(19) United States
(12) Patent Application Publication
(10) Pub. No.: US 2024/0329418 A1
(43) Pub. Date: Oct. 3, 2024

(54) BEAM COMBINER, METHOD OF FORMING ALIGNMENT FILM, AND METHOD OF MANUFACTURING OPTICAL ELEMENT

(71) Applicant: FUJIFILM Corporation, Tokyo (JP)

(72) Inventors: Koji IIJIMA, Minamiashigara-shi (JP); Takashi YONEMOTO, Minamiashigara-shi (JP); Hiroshi SATO, Minamiashigara-shi (JP); Masaaki SUZUKI, Minamiashigara-shi (JP)

(73) Assignee: FUJIFILM Corporation, Tokyo (JP)

(21) Appl. No.: 18/672,128

(22) Filed: May 23, 2024

Related U.S. Application Data
(63) Continuation of application No. PCT/JP2022/044592, filed on Dec. 2, 2022.

(30) Foreign Application Priority Data
Dec. 3, 2021 (JP) 2021-197029

(51) Int. Cl. G02B 27/28; G02B 5/30; G02B 27/09

(52) U.S. Cl. CPC G02B 27/283; G02B 5/3016; G02B 27/0955

(57) ABSTRACT

Provided are a beam combiner that can form a fine and clear interference pattern, a method of forming an alignment film in which a fine and clear alignment pattern can be obtained, and a method of manufacturing an optical element including a fine and clear liquid crystal alignment pattern. The beam combiner element includes: a beam combiner element that emits light where right/left circularly polarized light components are combined; a polarization separating element that separates incidence light into two right or left circularly polarized light components; and a light control element that focuses or diffuses light and is provided on at least one optical path of circularly polarized light incident into the beam combiner element, in which an absolute value of an ellipticity of circularly polarized light emitted from the beam combiner element is 0.8 or more.

### CROSS-REFERENCE TO RELATED APPLICATIONS

This application is a Continuation of PCT International Application No. PCT/JP2022/044592 filed on Dec. 2, 2022, which claims priority under 35 U.S.C. § 119(a) to Japanese Patent Application No. 2021-197029 filed on Dec. 3, 2021. The above applications are hereby expressly incorporated by reference, in their entirety, into the present application.

### BACKGROUND OF THE INVENTION

### 1. Field of the Invention

The present invention relates to a beam combiner that generates interference light, a method of forming an alignment film using the beam combiner, and a method of manufacturing an optical element using the alignment film.

### 2. Description of the Related Art

A beam combiner that causes two beams to interfere with each other to form an interference pattern is known.

For example, “Fabrication of ideal geometric-phase holograms with arbitrary wavefronts”, Optica Vol. 2, No. 11, November 2015, pp. 958-964 describes a beam combiner shown in FIG. 19.

This beam combiner 100 includes: a light source 102; a polarization beam splitter 104 that separates light M having coherence emitted from the light source 102; a mirror 106A that is disposed on an optical path of a part of the light separated by the polarization beam splitter 104; a mirror 106B that is disposed on an optical path of the remaining part of the light separated by the polarization beam splitter 104; a light control element 108; a half mirror 110; and a λ/4 plate 112.

In the beam combiner 100, the light M having coherence emitted from the light source 102 is separated into P-polarized light MP and S-polarized light MS by the polarization beam splitter 104.

The S-polarized light MS separated by the polarization beam splitter 104 is reflected from the mirror 106a, transmits through the light control element 108, and is incident into the half mirror 110. On the other hand, the P-polarized light MP separated by the polarization beam splitter 104 is reflected from the mirror 106b and is incident into the half mirror 110.

The P-polarized light MP is reflected from the half mirror 110. On the other hand, the S-polarized light MS transmitted through the light control element 108 transmits through the half mirror 110. As a result, the P-polarized light MP and the S-polarized light MS are combined with each other by the half mirror 110 to interfere with each other.

The P-polarized light MP and the S-polarized light MS are converted into right circularly polarized light and left circularly polarized light by the λ/4 plate 112 depending on polarization directions, and are incident into, for example, a photosensitive material Z to form an interference pattern. For example, in a case where the photosensitive material Z includes a coating film that includes a compound having a photo-aligned group, an alignment film having an alignment pattern corresponding to the interference pattern is obtained.

The beam combiner 100 can form various interference patterns depending on the light control element 108.

For example, in a case where a convex lens is used as the light control element 108, for example, as conceptually shown in FIG. 2 below, a concentric interference pattern including a pattern where a straight line changes while continuously rotating in one direction in a radial shape from the inner side toward the outer side is formed.

### SUMMARY OF THE INVENTION

In the beam combiner 100 described in “Fabrication of ideal geometric-phase holograms with arbitrary wavefronts”, Optica Vol. 2, No. 11, November 2015, pp. 958-964, as an angle at which light modulated by the light control element 108 is incident with respect to the normal line of the photosensitive material Z increases, that is, as an angle at which the light is incident into the photosensitive material Z increases, a fine interference pattern is obtained.

For example, in a case where the light control element 108 is a convex lens, by setting the focal point of the light control element 108 to be short to significantly expand the diameter of the light emitted from the half mirror 110, the light is incident into the photosensitive material Z at a wide angle, and a fine interference pattern is obtained.

Incidentally, according to an investigation by the present inventors, in the beam combiner in the related art such as the beam combiner 100 disclosed in “Fabrication of ideal geometric-phase holograms with arbitrary wavefronts”, Optica Vol. 2, No. 11, November 2015, pp. 958-964, in a case where a fine interference pattern is formed, there is a problem in that the interference pattern is unclear.

An object of the present invention is to solve the above-described problem of the related art and to provide a beam combiner that can obtain a fine and clear interference pattern, a method of forming an alignment film using the beam combiner, and a method of manufacturing an optical element using the alignment film formed using the method of forming an alignment film.

In order to achieve the object, the present invention has the following configurations.

[1] A beam combiner comprising:
a beam combiner element that includes a first surface through which at least a part of right circularly polarized light and left circularly polarized light transmits and a second surface from which at least a part of right circularly polarized light and left circularly polarized light is reflected and emits light where the light transmitted through the first surface and the light reflected from the second surface are combined;
a polarization separating element that separates light incident into the beam combiner element into two right circularly polarized light components or two left circularly polarized light components to convert the incidence light into right circularly polarized light or left circularly polarized light; and
at least one light control element that focuses or diffuses light and is provided on at least one of an optical path of the right circularly polarized light or the left circularly polarized light incident into the first surface of the beam combiner element or an optical path of circularly polarized light incident into the second surface of the beam combiner element and having the same turning direction as the circularly polarized light incident into the first surface,
in which an absolute value of an ellipticity of the right circularly polarized light or the left circularly polarized light incident into, transmitted through, and emitted from the first surface of the beam combiner element is 0.8 or more, and
an absolute value of an ellipticity of circularly polarized light incident into, reflected from, and emitted from the second surface of the beam combiner element and having a turning direction opposite to that of the circularly polarized light incident into, transmitted through, and emitted from the first surface of the beam combiner element is 0.8 or more.

[2] The beam combiner according to [1],
in which the polarization separating element includes a beam splitter that separates incidence light into two linearly polarized light components orthogonal to each other, a first polarization conversion element that converts one linearly polarized light separated by the beam splitter into the right circularly polarized light or the left circularly polarized light, and a second polarization conversion element that converts the other linearly polarized light separated by the beam splitter into circularly polarized light having the same turning direction as the circularly polarized light converted by the first polarization conversion element.

[3] The beam combiner according to [1],
in which the polarization separating element includes a layer that separates incident light into circularly polarized light components having opposite turning directions and is formed by immobilizing a cholesteric liquid crystal phase, and a polarization conversion element that converts one circularly polarized light separated by the layer formed by immobilizing the cholesteric liquid crystal phase into circularly polarized light having the same turning direction as the other circularly polarized light.

[4] The beam combiner according to any one of [1] to [3], further comprising:
a polarization compensating element that is provided between the light control element and the beam combiner element.

[5] The beam combiner according to [4], further comprising:
a polarization compensating element that is provided between the polarization separating element and the beam combiner element on an optical path where the light control element is not disposed.

[6] The beam combiner according to [4] or [5],
in which the polarization compensating element is a positive C-plate.

[7] The beam combiner according to [6],
in which a retardation during incidence of light having a wavelength λ into the positive C-plate from a direction of 45° with respect to a main surface is 0.12λ to 0.13λ, and
the positive C-plate is at least one of a first positive C-plate that is provided on an optical path of light incident into the first surface of the beam combiner element such that a main surface is disposed to form −45° with respect to an optical axis of the incidence light or a second positive C-plate that is provided on an optical path of light incident into the second surface of the beam combiner element such that a main surface is disposed to form +45° with respect to an optical axis of the incidence light, the optical path being an optical path where the light control element is not disposed.

[8] The beam combiner according to [4] or [5],
in which the polarization compensating element is an O-plate.

[9] The beam combiner according to [8],
in which the O-plate is at least one of
a first O-plate that is provided on an optical path of light incident into the first surface of the beam combiner element and where a direction having a highest refractive index is tilted by −45λ with respect to a main surface and a retardation during vertical incidence of light having a wavelength λ with respect to the direction having the highest refractive index is 0.24 to 0.26λ or
a second O-plate that is provided on an optical path of light incident into the second surface of the beam combiner element and where a direction having a highest refractive index is tilted by 450 with respect to a main surface and a retardation during vertical incidence of light having a wavelength λ with respect to the direction having the highest refractive index is 0.24 to 0.26λ.

[10] The beam combiner according to any one of [1] to [9],
in which in a case where parallel light is incident into the light control element, at least a part of the light emitted from the beam combiner element has an angle of 150 or more with respect to an optical axis of the light control element.

[11] A method of forming an alignment film, the method comprising:
irradiating a coating film including a compound having a photo-aligned group with light emitted from the beam combiner according to any one of [1] to [10].

[12] A method of manufacturing an optical element, the method comprising:
a step of applying a composition including a liquid crystal compound to an alignment film formed using the method of forming an alignment film according to [11] and drying the applied composition.

With the beam combiner according to an aspect of the present invention, a fine and clear interference pattern can be formed. In addition, in the method of forming an alignment film according to an aspect of the present invention, an alignment film having a fine and clear alignment pattern can be formed. Further, in the method of manufacturing an optical element according to an aspect of the present invention, an optical element having a fine and clear liquid crystal alignment pattern can be manufactured.

### BRIEF DESCRIPTION OF THE DRAWINGS

FIG. 1 is a diagram conceptually showing an example of a beam combiner according to the present invention.

FIG. 2 is a diagram conceptually showing an example of an interference pattern formed by the beam combiner according to the present invention.

FIG. 3 is a conceptual diagram showing an example of a polarization compensating element.

FIG. 4 is a conceptual diagram showing another example of the polarization compensating element.

FIG. 5 is a conceptual diagram showing another example of the beam combiner according to the present invention.

FIG. 6 is a schematic plan view showing an example of an optical element manufactured using a manufacturing method according to the present invention.

FIG. 7 is a schematic cross sectional view showing an example of the optical element manufactured using the manufacturing method according to the present invention.

FIG. 8 is a conceptual diagram showing the optical element manufactured using the manufacturing method according to the present invention.

FIG. 9 is a conceptual diagram showing the optical element manufactured using the manufacturing method according to the present invention.

FIG. 10 is a conceptual diagram showing the optical element manufactured using the manufacturing method according to the present invention.

FIG. 11 is a schematic cross sectional view showing another example of the optical element manufactured using the manufacturing method according to the present invention.

FIG. 12 is a conceptual diagram showing another example of the optical element manufactured using the manufacturing method according to the present invention.

FIG. 13 is a conceptual diagram showing another example of the optical element manufactured using the manufacturing method according to the present invention.

FIG. 14 is a conceptual diagram showing another example of the optical element manufactured using the manufacturing method according to the present invention.

FIG. 15 is a conceptual diagram showing another example of the beam combiner according to the present invention.

FIG. 16 is a conceptual diagram showing another example of the beam combiner according to the present invention.

FIG. 17 is a conceptual diagram showing another example of the beam combiner according to the present invention.

FIG. 18 is a conceptual diagram showing another example of the beam combiner according to the present invention.

FIG. 19 is a diagram conceptually showing an example of a beam combiner in the related art.

### DESCRIPTION OF THE PREFERRED EMBODIMENTS

Hereinafter, a beam combiner, a method of forming an alignment film, and a method of manufacturing an optical element according to the present invention will be described in detail based on preferable embodiments shown in the accompanying drawings.

The following description regarding components has been made based on a representative embodiment of the present invention. However, the present invention is not limited to the embodiment.

Further, all the drawings described below are conceptual views for describing the present invention. A size, a thickness, a positional relationship, and the like of each of members, portions, and the like do not necessarily match with the actual ones.

In the present specification, numerical ranges represented by “to” include numerical values before and after “to” as lower limit values and upper limit values.

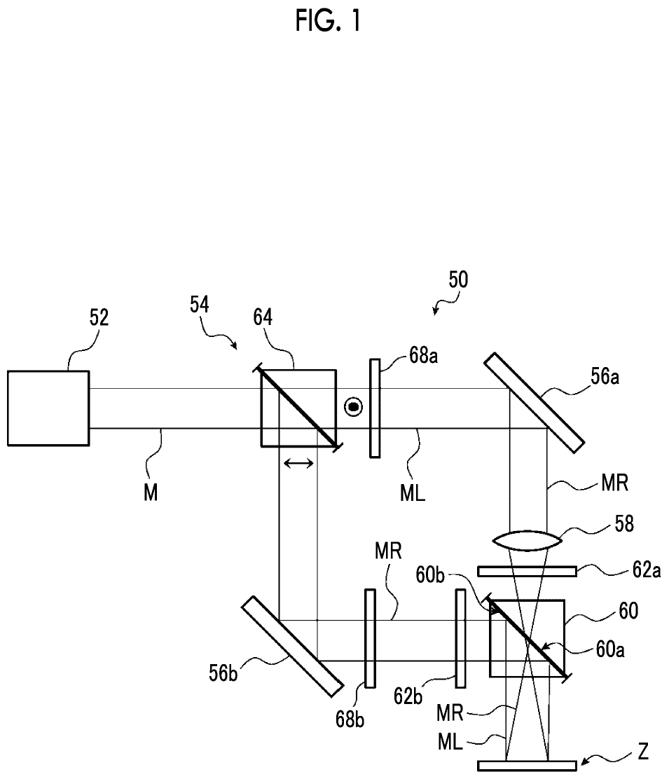

FIG. 1 conceptually shows an example of a beam combiner according to an embodiment of the present invention.

A beam combiner 50 shown in FIG. 1 includes a light source 52, a polarization separating element 54, mirrors 56a and 56b, a light control element 58, a beam combiner element 60, and polarization compensating elements 62a and 62b.

In the example shown in the drawing, the polarization separating element 54 includes a beam splitter element 64 and polarization conversion elements 68a and 68b.

In the beam combiner 50, light M having coherence emitted from the light source 52 is separated into two circularly polarized light components having the same turning direction by the polarization separating element 54, one of the circularly polarized light components is modulated by the light control element 58, and the two circularly polarized light components having the same turning direction are combined by the beam combiner element 60. In the example shown in the drawing, the polarization separating element 54 separates the light M into two right circularly polarized light components.

Here, among the two circularly polarized light components having the same turning direction, one circularly polarized light is reflected from a reflecting surface (second surface) of the beam combiner element 60 such that the turning direction is reversed. That is, the two circularly polarized light components having the same turning direction are converted into two circularly polarized light components having opposite turning directions by the beam combiner element 60.

In the beam combiner 50, by causing the two circularly polarized light components having opposite turning directions to be combined, to interfere with each other, and to be incident into the photosensitive material Z, an interference fringe is formed, and the photosensitive material Z is exposed to the interference fringe to form an interference pattern on the photosensitive material Z.

In the beam combiner 50, as the light source 52, a well-known light source can be used as long as light emitted from the light source has coherence. In particular, as the light source having excellent coherence, a laser light source is suitably used.

In addition, it is preferable that the light source 52 emits parallel light (collimated light). Accordingly, as the light source 52, for example, a light emitting element (light source) that emits parallel light, a combination of a light emitting element that emits diverging light and a collimating lens, a combination of a light emitting element that emits diverging light and an aperture, or a combination of a light emitting element that emits diverging light, an aperture, and a collimating lens is suitably used.

A wavelength of the light M emitted from the light source 52 is not limited, and may be appropriately set depending on a wavelength (photosensitive wavelength) to which the photosensitive material Z to be exposed has sensitivity.

The light M having coherence emitted from the light source 52 is incident into the beam polarization separating element 54.

The polarization separating element 54 separates the light M having coherence into two circularly polarized light components such as right circularly polarized light components MR or left circularly polarized light components ML having the same turning direction.

In the example shown in the drawing, the polarization separating element 54 includes the beam splitter element 64, the mirror 56a, and the polarization conversion elements 68a and 68b.

For example, the beam splitter element 64 separates the unpolarized light M emitted from the light source 52 into linearly polarized light components orthogonal to each other, for example, S-polarized light and P-polarized light.

The polarization conversion element 68a, the mirror 56a, and the polarization conversion element 68b convert the two linearly polarized light components separated by the beam splitter element 64 into two circularly polarized light components having the same turning direction for incidence into the beam combiner element 60.

In the example shown in the drawing, for example, the S-polarized light is incident into the polarization conversion element 68a. The polarization conversion element 68a converts the incident S-polarized light into left circularly polarized light ML. Next, the left circularly polarized light ML converted by the polarization conversion element 68a is reflected from the mirror 56a to be converted into right circularly polarized light MR.

On the other hand, the P-polarized light separated by the beam splitter element 64 is reflected from the mirror 56b to be incident into the polarization conversion element 68b. The polarization conversion element 68b converts the incident P-polarized light into the right circularly polarized light MR.

As a result, the polarization separating element 54 separates the light M having coherence emitted from the light source 52 into two right circularly polarized light components MR. Accordingly, in the example shown in the drawing, the two right circularly polarized light components MR are incident into the beam combiner element 60.

In the beam combiner 50 in the example shown in the drawing, among the polarization conversion element 68a and the mirror 56a and the polarization conversion element 68b, one corresponds to the first polarization conversion element according to the embodiment of the present invention, the other one corresponds to the second polarization conversion element according to the embodiment of the present invention.

As the beam splitter element 64, various well-known polarization beam splitters such as a cube type or a plate type can be used as long as they can separate the light M having coherence into linearly polarized light components orthogonal to each other.

In addition, as the beam splitter element 64, a combination of an optical element such as a half mirror or a non-polarization beam splitter that separates the light M having coherence and at least one polarizer can also be used. Light components separated by the half mirror, the non-polarization beam splitter, or the like are not linearly polarized light components orthogonal to each other. However, by using the half mirror, the non-polarization beam splitter, or the like in combination with the polarizer, linearly polarized light components orthogonal to each other can be obtained. Here, the polarizer is not particularly limited, and various well-known polarizers, for example, a reflective polarizer such as a wire grid polarizer, an absorptive polarizer having dichroism, or a polarization prism such as a Glan-Thompson prism can be suitably used.

Preferable examples of the polarization conversion elements 68a and 68b include a so-called ¼ wave plate (¼ retardation plate, λ/4 plate) that has an in-plane retardation (retardation Re) of about ¼ wavelength at the wavelength of the incidence light, that is, the S-polarized light and the P-polarized light.

As the ¼ wave plate, for example, a ¼ wave plate where a ratio between the retardation and the wavelength is 0.24 to 0.26 in the plane direction is preferable, and a ¼ wave plate where the ratio is 0.245 to 0.255 is more preferable.

The polarization conversion elements 68a and 68b may be used in combination with a plurality of optical elements. In this case, a retardation obtained by adding up retardations of a plurality of optical elements forming the polarization conversion elements 68a and 68b may be about ¼ wavelength.

In the beam combiner 50 according to the embodiment of the present invention, the polarization separating element 54 is not limited to the combination of the beam splitter element 64, the mirror, and the polarization conversion element (λ/4 wave plate), and various well-known optical elements that can separate incident light into two circularly polarized light components having the same turning direction can be used.

Preferable examples of the polarization separating element 54 used in the beam combiner 50 according to the embodiment of the present invention include a polarization separating element including: a cholesteric liquid crystal layer; and a polarization conversion element that converts one circularly polarized light separated by the cholesteric liquid crystal layer into circularly polarized light having the same turning direction as the other circularly polarized light.

The cholesteric liquid crystal layer is a layer obtained by immobilizing a cholesteric liquid crystal phase.

As is well known, the cholesteric liquid crystal layer (cholesteric liquid crystal phase) selectively reflects specific circularly polarized light having a specific wavelength, and transmits the other light. In addition, the light transmitted through the cholesteric liquid crystal layer is circularly polarized light.

Accordingly, in a case where the cholesteric liquid crystal layer has a selective reflection wavelength range in a wavelength range of emitted light from the light source 52, the polarization separating element 54 including the cholesteric liquid crystal layer reflects a specific circularly polarized light component and allows transmission of a circularly polarized light component having the opposite turning direction among the light components emitted from the light source 52 such that the incidence light can be separated into the right circularly polarized light MR and the left circularly polarized light ML.

For example, the polarization separating element 54 is configured using the cholesteric liquid crystal layer and the polarization conversion element that selectively reflect the right circularly polarized light in the wavelength range of the unpolarized light M emitted from the light source 52.

In this case, as in the beam combiner 50 shown in FIG. 1, in the unpolarized light M emitted from the light source 52, the left circularly polarized light component ML travels in the transverse direction in the drawing, is incident into the mirror 56a, and is converted into right circularly polarized light.

On the other hand, in the unpolarized light M emitted from the light source 52, the right circularly polarized light component MR is selectively reflected from the cholesteric liquid crystal layer forming the polarization separating element 54 and travels downward in the drawing. Here, the polarization conversion element that reverses the turning direction of circularly polarized light is disposed upstream of the mirror 56b. The right circularly polarized light MR transmitted through the polarization conversion element is converted into the left circularly polarized light ML, and the left circularly polarized light ML is incident into and reflected from the mirror 56b. Due to the reflection, the left circularly polarized light ML is converted into the right circularly polarized light MR that is the same as the other circularly polarized light.

As a result, the light M emitted from the light source 52 can be separated into two right circularly polarized light components MR.

The polarization conversion element that reverses the turning direction of circularly polarized light may be disposed downstream of the mirror 56b. In this case, the right circularly polarized light MR incident into the mirror 56b is reflected from the mirror 56b to be converted into the left circularly polarized light ML, and subsequently transmits through the polarization conversion element to be converted into the right circularly polarized light MR that is the same as the other circularly polarized light.

That is, in the present example, the cholesteric liquid crystal layer, two mirrors, and one polarization conversion element configure the polarization separating element.

Preferable examples of the polarization conversion elements that reverse the turning direction of circularly polarized light include a so-called ½ wave plate (½ retardation plate, λ/2 plate) that has an in-plane retardation of about ½ wavelength at the wavelength of the incident circularly polarized light.

As the ½ wave plate, for example, a ½ wave plate where a ratio between the retardation and the wavelength is 0.48 to 0.52 in the plane direction is preferable, and a ½ wave plate where the ratio is 0.49 to 0.51 is more preferable.

The ½ wave plate may be used in combination with a plurality of optical elements. In this case, a retardation obtained by adding up retardations of a plurality of optical elements forming the ½ wave plate may be about ½ wavelength.

In a case where the cholesteric liquid crystal layer is used for the polarization separating element 54, the polarization separating element 54 may be configured using one cholesteric liquid crystal layer or may be configured using a plurality of cholesteric liquid crystal layers.

For example, in a case where the light source 52 emits ultraviolet light in a specific narrow wavelength range, the polarization separating element 54 may be configured using one cholesteric liquid crystal layer that selectively reflects the ultraviolet light in the narrow wavelength range. Alternatively, in a case where the light source 52 emits white light, the polarization separating element 54 may be configured using three cholesteric liquid crystal layers including a cholesteric liquid crystal layer that selectively reflects red light, a cholesteric liquid crystal layer that selectively reflects green light, and a cholesteric liquid crystal layer that selectively reflects blue light.

The cholesteric liquid crystal layer will be described below.

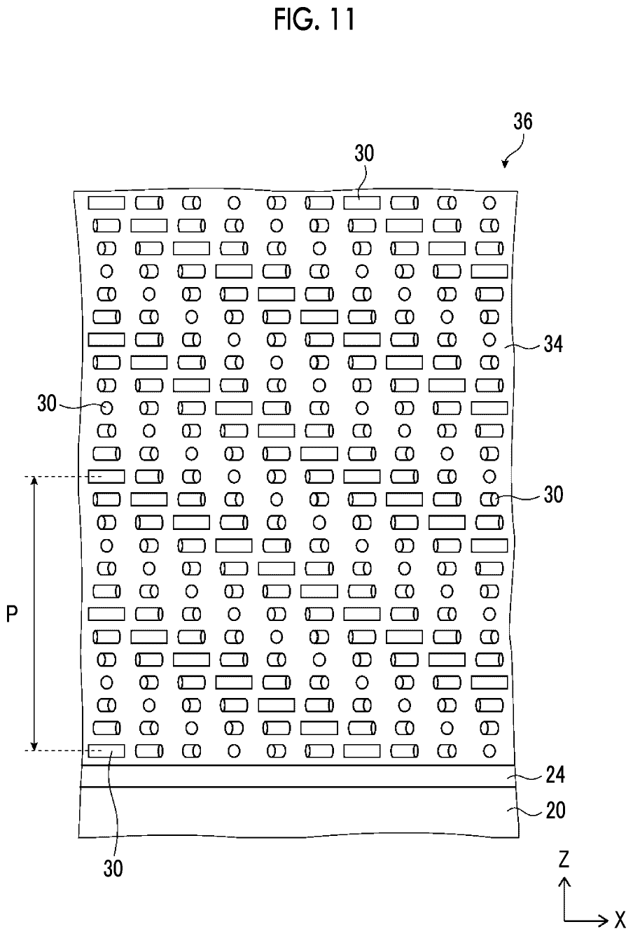

Note that the cholesteric liquid crystal layer used as the polarization separating element 54 is a typical cholesteric liquid crystal layer that does not have a liquid crystal alignment pattern unlike a cholesteric liquid crystal layer shown in FIG. 11 or the like below and where a liquid crystal compound is uniformly aligned on an alignment film surface.

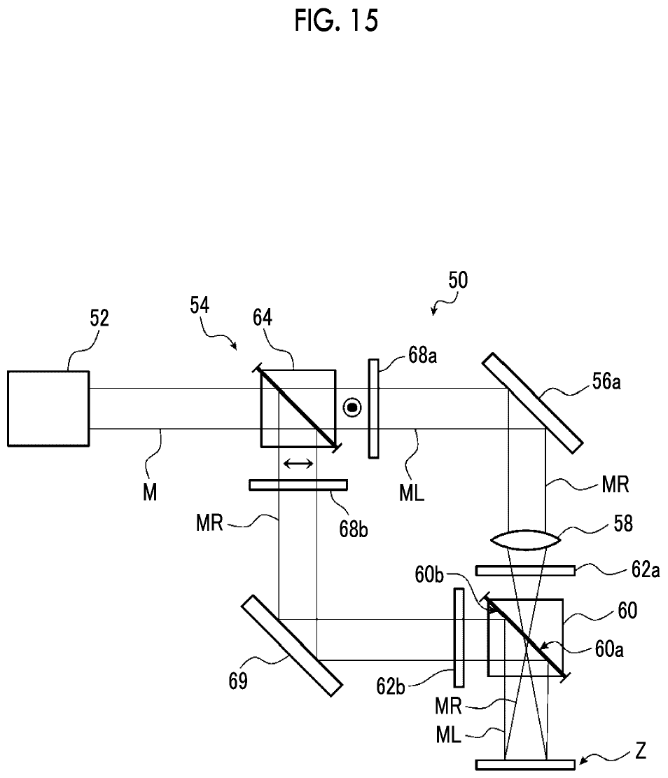

In addition, another example of the polarization separating element will be described with reference to FIG. 15 or the like below.

In the beam combiner 50 shown in FIG. 1, the polarization separating element 54 separates the light M having coherence emitted from the light source 52 into two right circularly polarized light components MR. However, the present invention is not limited to this configuration.

That is, in the beam combiner according to the embodiment of the present invention, the polarization separating element 54 may separate the light M having coherence emitted from the light source 52 into two left circularly polarized light components ML.

This configuration may be selected by appropriately setting the directions of linearly polarized light transmitted through and reflected from the polarization beam splitter, a direction of a slow axis of the polarization conversion element (¼ wave plate), the turning direction of circularly polarized light selectively reflected from the cholesteric liquid crystal layer, and the like.

As described above, the left circularly polarized light ML converted by the polarization conversion element 68a is reflected from the mirror 56a to be converted into the right circularly polarized light MR, and the right circularly polarized light MR is modulated by the light control element 58 to be incident into the beam combiner element 60. In the example shown in the drawing, the light control element 58 is, for example, a convex lens. Accordingly, light transmitted through the light control element 58 is focused such that the diameter expands in and after the focal point. The light control element 58 will be described below.

On the other hand, the P-polarized light reflected from the mirror 56b is converted into the right circularly polarized light MR by the polarization conversion element 68b, and the right circularly polarized light MR is incident into the beam combiner element 60.

That is, the two right circularly polarized light components MR are incident into the beam combiner element 60.

Here, in the beam combiner 50 in the example shown in the drawing, in a preferable aspect, the polarization compensating element 62a is provided between the light control element 58 and the beam combiner element 60. In addition, in the beam combiner 50 in the example shown in the drawing, in a more preferable aspect, the polarization compensating element 62b is provided between the mirror 56b and the beam combiner element 60 on an optical path where the light control element 58 is not provided.

The polarization compensating elements 62a and 62b adjust the polarization state of circularly polarized light incident into the beam combiner element 60 such that the right circularly polarized light MR and the left circularly polarized light ML emitted from the beam combiner element 60 are appropriate circularly polarized light components.

The polarization compensating elements 62a and 62b will be described below in detail. In the example shown in the drawing, the circularly polarized light incident into the beam combiner element 60 is the right circularly polarized light MR.

The beam combiner element 60 includes: a beam combiner element that includes a first surface 60a through which at least a part of incidence light transmits; and a second surface 60b from which at least a part of the incidence light is reflected. In the example shown in the drawing, the right circularly polarized light MR is incident into the first surface 60a and the second surface 60b. However, as described above regarding the polarization separating element 54, the present invention is not limited to this configuration, and left circularly polarized light may be incident into both of the first surface 60a and the second surface 60b.

The right circularly polarized light MR incident into the second surface 60b of the beam combiner element 60 is reflected from the second surface 60b to be converted into the left circularly polarized light ML. The right circularly polarized light MR incident into and transmitted through the first surface 60a of the beam combiner element 60 and the left circularly polarized light ML incident into and reflected from the second surface 60b of the beam combiner element 60 are combined and emitted from the beam combiner element 60.

In the following description, in order to simplify the sentences, “at least a part” in the description “at least a part of incidence light transmits”, “at least a part of the incidence light is reflected”, and the like is omitted.

The right circularly polarized light MR incident into and transmitted through the first surface 60a and the left circularly polarized light ML incident into and reflected from the second surface 60b are combined as shown in FIG. 1. As described above, the right circularly polarized light MR and the left circularly polarized light ML are originally separated from the same light M having coherence. Accordingly, the right circularly polarized light MR and the left circularly polarized light ML that are combined interfere with each other.

The beam combiner element 60 is not limited, and any well-known elements can be used as long as they include the first surface 60a through which incidence light transmits and the second surface 60b from which the incidence light is reflected and can combine the light incident into and transmitted through the first surface 60a and the light reflected from the second surface 60b.

As the beam combiner element 60, for example, a well-known beam splitter such as a cube type or a plate type, a half mirror, and the like can be used.

It is preferable that the beam combiner element has properties of allowing the transmission of the right circularly polarized light MR and the left circularly polarized light ML without converting the polarization states and allowing the reflection of the right circularly polarized light MR and the left circularly polarized light ML without converting the polarization states.

In addition, the beam combiner element may be a non-polarized light beam combiner (non-polarized light beam splitter) or may be an unpolarized light beam combiner (unpolarized light beam splitter).

The non-polarized light beam combiner refers to a combiner where light components are combined such that an intensity ratio of transmitted light and reflected light that are emitted to incidence light is a specific ratio without controlling a polarization component ratio between an S component and a P component.

On the other hand, the unpolarized light beam combiner refers to a combiner where light components are combined such that an intensity ratio of transmitted light and reflected light that are emitted to incidence light is a specific ratio while maintaining a polarization component ratio between an S component and a P component of the incidence light irrespective of polarization. In the present invention, in a case where an unpolarized light beam combiner is used, it is preferable to use a combiner where the intensity ratio of transmitted light and reflected light that are emitted is 1:1 such that the intensities of right circularly polarized light and left circularly polarized light match with each other.

Here, in the beam combiner 50 according to the embodiment of the present invention, it is more preferable to use the unpolarized light beam combiner as the beam combiner element 60.

It is preferable to use the unpolarized light beam combiner as the beam combiner element 60 from the viewpoint that, for example, an absolute value of an ellipticity of light emitted from the beam combiner element 60 described below is further approximated to 1 as compared to a case where the non-polarized light beam combiner is used.

The right circularly polarized light MR and the left circularly polarized light ML combined by the beam combiner element 60 are incident into the photosensitive material Z. Examples of the photosensitive material Z include a material where a coating film including a compound having a photo-aligned group as a photo-alignment film is formed on a substrate.

As described above, in the beam combiner 50, by causing two circularly polarized light components having opposite turning directions to interfere with each other and to be incident into a photosensitive material Z, an interference fringe is formed, and the photosensitive material Z is exposed to the interference fringe to form an interference pattern on the photosensitive material Z.

In the beam combiner 50, the interference pattern to be formed changes depending on the light control element 58. In other words, by selecting the light control element 58 to be used, the interference pattern to be formed can be selected.

As described above, in the beam combiner 50 in the example shown in the drawing, the light control element 58 is, for example, a convex lens.

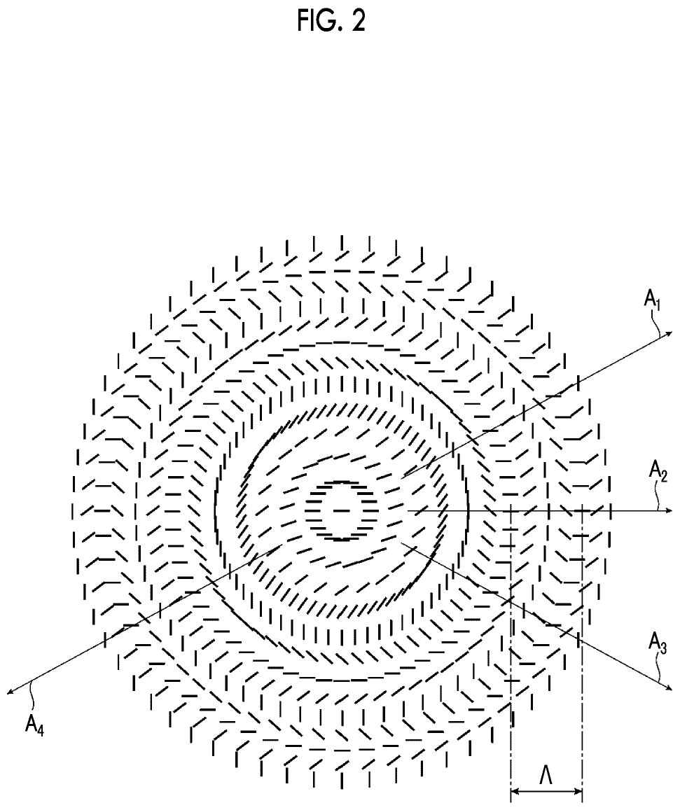

In a case where the light control element 58 is a convex lens, as conceptually shown in FIG. 2, the concentric interference pattern that is formed on the photosensitive material Z by the beam combiner 50 includes a pattern where a short straight line changes while continuously rotating in one direction in a radial shape as indicated by an arrow in the drawing. In other words, in a case where the light control element 58 is a convex lens, the interference pattern that is formed on the photosensitive material Z by the beam combiner 50 is a concentric interference pattern that includes one direction in which a short straight line changes while continuously rotating in a concentric shape from an inner side toward an outer side as shown in FIG. 2. That is, this alignment pattern is a pattern including circles (annuli) formed by short straight lines having the same orientation in a concentric shape.

In the beam combiner 50, due to the interference between right circularly polarized light and left circularly polarized light, the polarization state of light to be irradiated on the photosensitive material Z periodically changes according to the interference fringe.

Here, as shown in FIG. 1, the right circularly polarized light MR is focused by the light control element 58 (convex lens) and is diffused in and after the focal point. As a result, an intersection state between the left circularly polarized light ML and the right circularly polarized light MR changes from the inner side to the outer side of the concentric circle. As a result, an interference pattern where the period decreases from the inner side toward the outer side is obtained. Thus, in the photosensitive material Z, the interference pattern having a radial shape (concentric shape) where the interference pattern periodically changes is obtained.

Specifically, in the interference pattern, a short straight line changes while continuously rotating in a plurality of directions from the center toward the outer side, for example, a direction indicated by an arrow A₁, a direction indicated by an arrow A₂, a direction indicated by an arrow A₃, a direction indicated by an arrow A₄, or . . . . In the following description, the short straight line of which the orientation changes while continuously rotating will be referred to as “short line” for convenience of description.

The rotation direction of the short line is the same direction in all of the directions (one direction). In the example shown in the drawing, in all the directions including the direction indicated by the arrow A₁, the direction indicated by the arrow A₂, the direction indicated by the arrow A₃, and the direction indicated by the arrow A₄, the rotation direction of the short line is counterclockwise.

That is, in a case where the arrow A₁ and the arrow A₄ are assumed as one straight line, the rotation direction of the short line is reversed at the center on the straight line. For example, the straight line formed by the arrow A₁ and the arrow A₄ is directed in the right direction (arrow A1 direction) in the drawing. In this case, the short line initially rotates clockwise from the outer side toward the center, the rotation direction is reversed at the center, and then the short line rotates counterclockwise from the center toward the outer side.

In addition, in the interference pattern, in a case where a length over which the orientation of the short line rotates by 180° in the one direction in which the direction of the short line changes while continuously rotating is set as a single period Λ, the length of the single period Λ gradually decreases from the inner side toward the outer side. The single period Λ will be described below.

In the beam combiner according to the embodiment of the present invention, the light control element 58 is not limited to a convex lens, and various optical elements can be used.

As the light control element 58, not only a spherical lens called a convex lens and a concave lens but also an aspherical lens can be suitably used.

For example, by using a lens array in which a plurality of lenses are arranged in a plane as the light control element 58, an interference pattern where a plurality of concentric circles are arranged can be formed.

In the beam combiner according to the embodiment of the present invention, the light control element 58 is not limited to an element that focuses light. For example, in a case where the single period of the interference pattern (alignment pattern) to be formed is long, a lens such as a concave lens that diffuses light may be used as the light control element 58.

An object to be irradiated, for example, the photosensitive material Z may be disposed outside or inside the focal point of the light control element 58.

By disposing the object to be irradiated outside the focal point of the light control element 58, a space where the beam combiner element 60, the polarization conversion elements 68a and 68b, and the like are disposed can be secured between the light control element 58 and the object to be irradiated. In addition, by disposing the object to be irradiated inside the focal point of the light control element 58, the beam combiner 50 can be minimized.

In addition, for example, in order to suppress aberration and to improve the degree of freedom of the interference pattern, the light control element 58 may be configured by combining a plurality of optical elements.

For example, a convex lens that focuses light and a concave lens that diffuses light may be combined to configure the light control element 58 that focuses light as in a convex lens as a whole.

In addition, the light control element 58 may be a relay optical system where a plurality of lenses are disposed according to the respective focal lengths. By configuring the light control element 58 as the relay optical system, a space where a large optical element is disposed can be secured.

In the beam combiner 50 in the example shown in the drawing, the light control element 58 is disposed on only the optical path of light incident into the first surface 60a of the beam combiner element 60. However, the present invention is not limited to this example.

That is, the light control element 58 may be disposed only on the optical path of light incident into the second surface 60b of the beam combiner element 60, or may be disposed on both of the optical path of light incident into the first surface 60a of the beam combiner element 60 and the optical path of the second surface 60b. Note that, in a case where the light control element 58 is disposed on both of the optical paths of light incident into the beam combiner element 60, the light control element 58 disposed on one optical path is different from that disposed on the other optical path.

In this case, for example, a pattern is formed by interference of two spherical waves, and thus the degree of freedom of the interference pattern can be improved.

In addition, the disposition position of the light control element 58 is not limited to only the upstream of the beam combiner element 60, and various positions can be used. In this case, a plurality of light control elements 58 may be disposed.

For example, in a state where the light control element 58 is disposed on at least one of the optical path of light incident into the first surface 60a of the beam combiner element 60 or the optical path of light incident into the second surface 60b of the beam combiner element 60, the light control element 58 may be further disposed between the beam combiner element 60 and the photosensitive material Z.

In the present invention, the upstream and the downstream refer to the upstream and the downstream in a light traveling direction from the light source 52 to the photosensitive material Z.

Incidentally, the right circularly polarized light MR transmitted through the first surface 60a of the beam combiner element 60 is focused by the light control element 58 (convex lens) and is diffused in and after the focal point. That is, a part of the right circularly polarized light MR transmitted through and emitted from the first surface 60a of the beam combiner element 60 has an angle with respect to the optical axis.

As the angle of the right circularly polarized light MR increases, the interference pattern formed on the photosensitive material Z is fine. Specifically, in a case where a direction perpendicular to the main surface of the photosensitive material Z, that is, the normal direction is set to 0°, as the angle at which the right circularly polarized light MR is incident into the photosensitive material Z increases, a fine interference pattern can be obtained. That is, as the angle at which the right circularly polarized light MR is incident into the photosensitive material Z increases, a fine interference pattern is formed on the photosensitive material Z.

For example, as shown in FIG. 2, in the pattern where the short line changes while continuously rotating in the one direction, as the angle at which the right circularly polarized light MR is incident into the photosensitive material Z increases, the length of the single period Λ over which the short line rotates by 180° in the one direction (the direction of the arrow) decreases, and a fine interference pattern can be obtained.

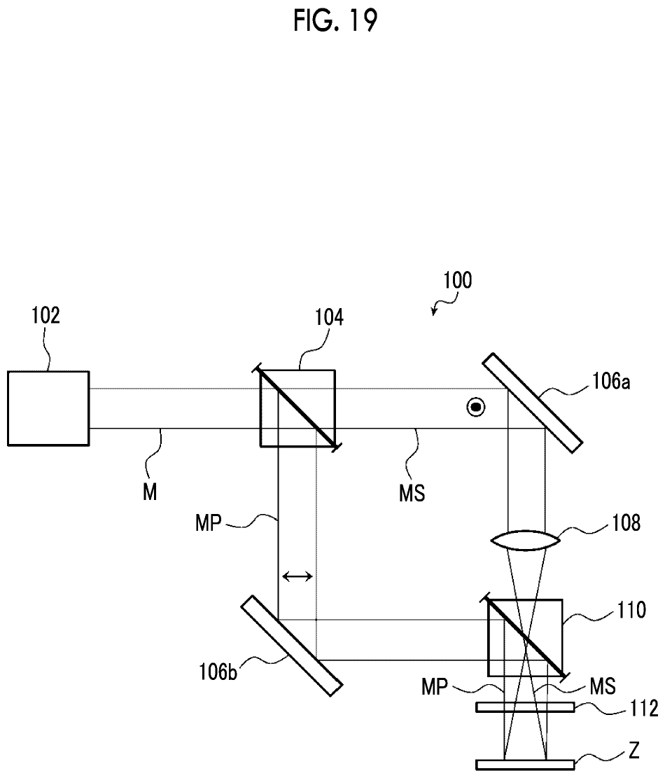

In the beam combiner in the related art disclosed in “Fabrication of ideal geometric-phase holograms with arbitrary wavefronts”, Optica Vol. 2, No. 11, November 2015, pp. 958-964 shown in FIG. 19, in a case where a fine interference pattern is formed, there is a problem in that the interference pattern is unclear. In particular, a fine interference pattern where the single period Λ is 1.2 μm or less is unclear.

The present inventors repeated an investigation on this point. As a result, it was found that, in the beam combiner in the related art, in a case where circularly polarized light is incident into the photosensitive material Z, the circularly polarized light collapses to approach elliptically polarized light, which is the reason why the interference pattern is unclear.

As described above, in the beam combiner, by causing circularly polarized light components having opposite turning directions to interfere with each other, the above-described concentric interference pattern is formed.

Here, in the beam combiner, the polarized light that is focused by the light control element is incident into the beam combiner element. Therefore, the focused polarized light is obliquely incident into the beam combiner element. In this case, the polarized light collapses such that the circularly polarized light components cannot appropriately interfere with each other. Therefore, the interference pattern is unclear.

Further as described above, as the angle at which light is incident into the photosensitive material Z increases, a fine interference pattern can be formed on the photosensitive material Z. In addition, on the other hand, as the angle at which light is incident into the photosensitive material Z increases, the angle at which light is obliquely incident into the beam combiner element also increases. Therefore, the interference pattern is more unclear.

On the other hand, in the beam combiner 50 according to the embodiment of the present invention, an absolute value of an ellipticity of the right circularly polarized light MR and the left circularly polarized light ML emitted from the beam combiner element 60 is 0.8 or more.

That is, in the beam combiner 50 according to the embodiment of the present invention, an absolute value of an ellipticity of the right circularly polarized light MR or the left circularly polarized light ML incident into, transmitted through, and emitted from the first surface 60a of the beam combiner element 60 is 0.8 or more, and an absolute value of an ellipticity of circularly polarized light incident into, reflected from, and emitted from the second surface 60b of the beam combiner element 60 and having a turning direction opposite to that of the circularly polarized light incident into, transmitted through, and emitted from the first surface 60a is 0.8 or more.

The beam combiner 50 according to the embodiment of the present invention has the above-described configuration. As a result, appropriate circularly polarized light components can be caused to interfere with each other on the downstream side of the beam combiner element 60.

Thus, with the beam combiner 50 according to the embodiment of the present invention, a fine and clear interference pattern can be formed on the photosensitive material Z.

From the viewpoints that, for example, a more appropriate concentric interference pattern can be obtained and a finer concentric interference pattern can be obtained due to appropriate interference of circularly polarized light components, the absolute value of the ellipticity of the right circularly polarized light MR and the left circularly polarized light ML emitted from the beam combiner element 60 is preferably 0.9 or more.

A method of adjusting the absolute value of the ellipticity of the right circularly polarized light MR and the left circularly polarized light ML emitted from the beam combiner element 60 to be 0.8 or more is not limited, and various methods can be used.

For example, as described above, a method of using the unpolarized light beam combiner as the beam combiner element 60 can be used. The unpolarized light beam combiner can adjust an intensity ratio of transmitted light and reflected light that are emitted to incidence light to be a specific ratio while maintaining a polarization component ratio between an S component and a P component of the incidence light. Therefore, although described below in Examples, by using the unpolarized light beam combiner as the beam combiner element 60, the absolute value of the ellipticity of the right circularly polarized light MR and the left circularly polarized light ML emitted from the beam combiner element 60 can be adjusted to be 0.8 or more.

As another method of adjusting the absolute value of the ellipticity of the right circularly polarized light MR and the left circularly polarized light ML emitted from the beam combiner element 60 to be 0.8 or more, for example, a method of providing the polarization compensating elements 62a and 62b upstream of the beam combiner element 60 on the optical path of the circularly polarized light as in the beam combiner 50 shown in FIG. 1 can be used.

The polarization compensating element slightly collapses the circularly polarized light incident into the beam combiner element 60 to compensate for, that is, offset the collapse of the circularly polarized light by the beam combiner element 60 such that the absolute value of the ellipticity of the circularly polarized light emitted from the beam combiner element 60 is 0.8 or more.

In the present invention, it is more preferable that the unpolarized light beam combiner is used as the beam combiner element 60 and the polarization compensating element is provided.

As the polarization compensating elements 62a and 62b, for example, a positive C-plate or an O-plate can be used.

As the positive C-plate and the O-plate, various well-known positive C-plates and O-plates can be used.

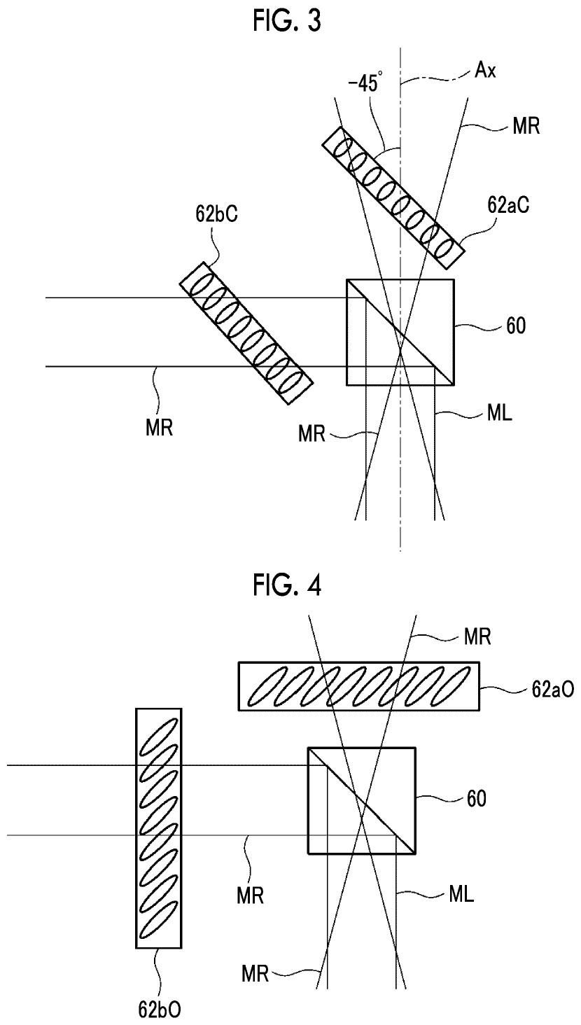

FIG. 3 conceptually shows an example of a case where the positive C-plate is used as the polarization compensating elements 62a and 62b.

There are two kinds of C-plates: a positive C-plate (positive C-plate, +C-plate) and a negative C-plate (negative C-plate, −C-plate). The positive C-plate satisfies a relationship of Expression (C1) and the negative C-plate satisfies a relationship of Expression (C2) assuming that a refractive index in a film in-plane slow axis direction (in a direction in which an in-plane refractive index is maximum) is defined as nx, a refractive index in an in-plane direction orthogonal to the in-plane slow axis is defined as ny, and a refractive index in a thickness direction is defined as nz. Rth as a thickness direction retardation of the positive C-plate has a negative value, and Rth of the negative C-Plate has a positive value.

nz>nx≈ny Expression (C1):

nz<nx≈ny Expression (C2):

“≈” described above represents not only a case where both elements are the same but also a case where both elements are substantially the same. Regarding the meaning of “substantially the same”, “nx≈ny” includes a case where “(nx−ny)×d” is 0 to 10 nm and preferably 0 to 5 nm. In (nx−nz)×d, d represents the thickness of the film.

In the example shown in FIG. 3, a positive C-plate 62aC is disposed on the polarization compensating element 62a on the optical path of the right circularly polarized light MR focused by the light control element 58, and a positive C-plate 62bc is disposed as the polarization compensating element 62b on the optical path of the right circularly polarized light MR that does not transmit through the light control element 58. The positive C-plate 62aC and the positive C-plate 62bc are the same.

In a case where the positive C-plate is used as the polarization compensating element, as shown in FIG. 3, it is preferable that the positive C-plate 62aC disposed on the optical path of the right circularly polarized light MR focused by the light control element 58 is disposed to be tilted such that an angle of the main surface with respect to an optical axis Ax of the corresponding circularly polarized light −45°. In other words, it is preferable that the positive C-plate 62aC is disposed such that circularly polarized light is incident from a direction of −45° with respect to the main surface.

On the other hand, it is preferable that the positive C-plate 62bC disposed on the optical path of the right circularly polarized light MR of parallel light not focused by the light control element 58 is disposed to be tilted such that an angle of the main surface with respect to the optical axis Ax of the corresponding circularly polarized light +45°. In other words, it is preferable that the positive C-plate 62bC is disposed such that circularly polarized light is incident from a direction of +450 with respect to the main surface.

In this case, the plus/minus of the angle represents whether an angle between the optical axis and a slow axis (a film thickness direction of the positive C-plate) is plus or minus.

The main surface is each of the maximum surfaces of a sheet-shaped material (a film, a plate-shaped material, or a layer), that is, both surfaces in the thickness direction. In addition, the normal line is a line perpendicular to the main surface, and is typically the thickness direction of the sheet-shaped material. In the positive C-plate, typically, the main surfaces are an incident surface and an emission surface of light, and thus the normal line is a line perpendicular to the incident surface and the emission surface of light.

Further, in the positive C-plates 62aC and 62bc, a retardation during incidence of light having a wavelength λ from a direction of −45° or +45° with respect to the main surface is preferably 0.12λ to 0.13λ.

As a result, this configuration is preferable from the viewpoint that, for example, the absolute value of the ellipticity of circularly polarized light emitted from the beam combiner element 60 can be more suitably adjusted to be 0.8 or more.

In the positive C-plates 62aC and 62bc, the retardation during the incidence of light having the wavelength λ from the direction of 45° with respect to the main surface is more preferably 0.123λ to 0.127λ.

In the general beam combiner element 60, regarding light incident from a direction closer to the normal direction of the reflecting surface, the effect of polarization is small, and a change in polarization state is small. Conversely, regarding light incident at a large angle with respect to the normal direction of the reflecting surface, the effect of polarization by the beam combiner element 60 is large, and the polarization state largely changes.

Accordingly, regarding light from the upper right direction toward the lower left direction in the drawing in the right circularly polarized light MR focused by the light control element 58, a change in polarization state by the beam combiner element 60 is small. Conversely, regarding light from the upper left direction toward the lower right direction in the drawing in the right circularly polarized light MR focused by the light control element 58, the polarization state by the beam combiner element 60 largely changes.

As described above, the C-plate has a retardation in the thickness direction, that is, the normal direction instead of having a retardation in the in-plane direction. For example, as shown in FIG. 3, as long as the C-plate is manufactured by aligning a rod-like liquid crystal compound, the rod-like liquid crystal compound is aligned such that a longitudinal direction matches with the thickness direction.

As shown in FIG. 3, the positive C-plate 62aC is disposed on the optical path of the right circularly polarized light MR focused by the light control element 58 such that the main surface is tilted by −45° with respect to the optical axis Ax of the right circularly polarized light MR.

In this state, in the right circularly polarized light MR focused by the light control element 58, light traveling from the upper right side toward the lower left side in the drawing is incident into the positive C-plate 62aC from a direction relatively close to the normal line as shown in FIG. 3, and transmits through the positive C-plate 62aC on a path close to the thickness direction, that is, the direction having a retardation. Accordingly, regarding the right circularly polarized light MR, a change in polarization by the positive C-plate 62aC is small.

Here, as described above, regarding the right circularly polarized light MR that travels in this direction, a change in polarization by the beam combiner element 60 is also small.

Accordingly, regarding the light traveling from the upper right side toward the lower left side in the drawing, the small change in polarization by the beam combiner element 60 is suitably compensated for, that is, is cancelled out by the small adjustment of polarization by the positive C-plate 62aC, and the absolute value of the ellipticity of the right circularly polarized light MR transmitted through the beam combiner element 60 can be adjusted to be 0.8 or more.

On the other hand, in the right circularly polarized light MR focused by the light control element 58, light traveling from the upper left side toward the lower right side in the drawing is incident into the positive C-plate 62aC at a large angle with respect to the normal line as shown in FIG. 3, and transmits through the positive C-plate 62aC at a large angle with respect to the thickness direction, that is, the direction having a retardation. Accordingly, regarding the right circularly polarized light MR, the polarization state largely changes by the positive C-plate 62aC.

Here, as described above, regarding the right circularly polarized light MR that travels in this direction, a change in polarization by the beam combiner element 60 is also large.

Accordingly, regarding the light traveling from the upper left side toward the lower right side in the drawing, the large change in polarization by the beam combiner element 60 is sufficiently compensated for, that is, is cancelled out by the large adjustment of polarization by the positive C-plate 62aC, and the absolute value of the ellipticity of the right circularly polarized light MR transmitted through the beam combiner element 60 can be adjusted to be 0.8 or more.

As a result, the absolute value of the ellipticity of the right circularly polarized light MR focused by the light control element 58 and transmitted through the beam combiner element 60 can be adjusted to be 0.8 or more by the compensation of polarization by the positive C-plate 62aC.

In particular, in a case where a retardation during incidence of light having the wavelength λ into the positive C-plate 62aC from a direction of −45° with respect to the main surface is 0.12λ to 0.13λ, the absolute value of the ellipticity of the right circularly polarized light MR transmitted through the beam combiner element 60 can be suitably adjusted to be 0.8 or more.

On the other hand, as shown in FIG. 3, the positive C-plate 62bC is disposed on the optical path of the right circularly polarized light MR of parallel light not focused by the light control element 58 such that the main surface is tilted by +45° with respect to the optical axis Ax of the right circularly polarized light MR.

The right circularly polarized light MR that travels on the optical path where the light control element 58 is not disposed is parallel light, and is incident into the reflecting surface of the beam combiner element 60 at the same angle (+45°) over the entire region in the direction orthogonal to the optical axis. That is, the change in polarization by the beam combiner element 60 is the same over the entire region in the direction orthogonal to the optical axis.

Likewise, as shown in FIG. 3, the right circularly polarized light MR that travels on the optical path where the light control element 58 is not disposed is incident into the positive C-plate 62bc at the same angle over the entire region in the direction orthogonal to the optical axis. That is, the right circularly polarized light MR that is not focused transmits through the positive C-plate 62bc at the same angle (+45°) with respect to the direction having a maximum refractive index of the positive C-plate 62bc, that is, a retardation over the entire region in the direction orthogonal to the optical axis. That is, regarding the right circularly polarized light MR that is not focused by the light control element 58, the change in polarization by the positive C-plate 62bc is the same over the entire region in the direction orthogonal to the optical axis.

By disposing the positive C-plate 62bc on the optical path, the right circularly polarized light MR that transmits through the beam combiner element 60 without being focused by the light control element 58 can be adjusted to appropriate circularly polarized light by the compensation of polarization by the positive C-plate 62bc.

In particular, in a case where a retardation during incidence of light having the wavelength λ into the positive C-plate 62bC from a direction of +45° with respect to the main surface is 0.12λ to 0.13λ, the absolute value of the ellipticity of the left circularly polarized light ML emitted from the beam combiner element 60 can be suitably adjusted to be 0.8 or more.

On the other hand, the O-plate is an optical element where a liquid crystal compound is tilted and aligned with respect to the thickness direction, that is, the normal direction. That is, in the O-plate, a direction having a highest refractive index is tilted with respect to the thickness direction, that is, the normal direction.

FIG. 4 conceptually shows an example of a case where the O-plate is used as the polarization compensating elements 62a and 62b.

In the example shown in FIG. 4, an O-plate 62aO is disposed on the polarization compensating element 62a on the optical path of the right circularly polarized light MR focused by the light control element 58, and an O-plate 62bO is disposed as the polarization compensating element 62b on the optical path of the right circularly polarized light MR of parallel light that does not transmit through the light control element 58.

The O-plate 62aO and the O-plate 62bO are disposed such that the normal line and the direction of the optical axis of incident circularly polarized light match with each other. That is, in the O-plate 62aO and the O-plate 62bO, the main surface and the optical axis of circularly polarized light are disposed orthogonal to each other, and circularly polarized light is incident from the normal direction.

As shown in FIG. 4, in the O-plate 62aO, in a preferable aspect, a direction having a highest refractive index, that is, an alignment direction of a liquid crystal compound is tilted by −45° with respect to the main surface.

On the other hand, in the O-plate 62bO, in a preferable aspect, a direction having a highest refractive index, that is, an alignment direction of a liquid crystal compound is tilted by +45° with respect to the main surface.

The alignment direction of the liquid crystal compound is specifically an alignment direction of an optical axis of the liquid crystal compound and, in the case of a rod-like liquid crystal compound as in the example shown in the drawing, is an alignment of a longitudinal direction.

In this case, the plus/minus of the angle represents whether an angle between the optical axis and a slow axis (an optical axis direction of the liquid crystal compound) is plus or minus.

In addition, in the O-plate 62aO and the O-plate 62bO, a retardation during incidence of light having the wavelength λ from a direction orthogonal to the alignment direction of the liquid crystal compound is preferably 0.24λ to 0.26λ. Further, in the O-plate 62aO and the O-plate 62bO, a retardation during incidence of light having the wavelength λ from a direction of −45° or +45° with respect to the main surface is preferably 0.24λ to 0.26λ.

As a result, this configuration is preferable from the viewpoint that, for example, the absolute value of the ellipticity of circularly polarized light emitted from the beam combiner element 60 can be more suitably adjusted to be 0.8 or more.

Further, in the O-plate 62aO and the O-plate 62bO, the retardation during the incidence of light having the wavelength λ from the direction orthogonal to the direction having the highest refractive index is more preferably 0.245λ to 0.255λ.

As described above, in the O-plate, the liquid crystal compound is tilted and aligned with respect to the normal direction and the direction having the highest refractive index is tilted with respect to the normal direction.

As shown in FIG. 4, the O-plate 62aO is disposed on the optical path of the right circularly polarized light MR focused by the light control element 58. In the O-plate 62aO, the liquid crystal compound is tilted and aligned at an angle of −45° with respect to the main surface.

In this state, in the right circularly polarized light MR focused by the light control element 58, light traveling from the upper right toward the lower left side in the drawing transmits through the O-plate 62aO on a path close to the tilt alignment direction of the liquid crystal compound as shown in FIG. 4. Accordingly, regarding the right circularly polarized light MR, a change in polarization by the O-plate 62aO is small.

Here, as described above, regarding the right circularly polarized light MR that travels in this direction, a change in polarization by the beam combiner element 60 is also small.

Accordingly, regarding the light traveling from the upper right side toward the lower left side in the drawing, the small change in polarization by the beam combiner element 60 is suitably compensated for, that is, is cancelled out by the small adjustment of polarization by the O-plate 62aO, and the absolute value of the ellipticity of the right circularly polarized light MR transmitted through the beam combiner element 60 can be adjusted to be 0.8 or more.

On the other hand, in the right circularly polarized light MR focused by the light control element 58, light traveling from the upper left side toward the lower right side in the drawing transmits through the O-plate 62aO at a large angle with respect to the tilt alignment direction of the liquid crystal compound as shown in FIG. 4. Accordingly, regarding the right circularly polarized light MR, the polarization state largely changes by the O-plate 62aO.

Here, as described above, regarding the right circularly polarized light MR that travels in this direction, a change in polarization by the beam combiner element 60 is also large.

Accordingly, regarding the light traveling from the upper left side toward the lower right side in the drawing, the large change in polarization by the beam combiner element 60 is sufficiently compensated for, that is, is cancelled out by the large adjustment of polarization by the O-plate 62aO, and the absolute value of the ellipticity of the right circularly polarized light MR transmitted through the beam combiner element 60 can be adjusted to be 0.8 or more.

As a result, the absolute value of the ellipticity of the right circularly polarized light MR focused by the light control element 58 and transmitted through the beam combiner element 60 can be adjusted to be 0.8 or more by the compensation of polarization by the O-plate 62aO.

In particular, in the O-plate 62aO, in a case where the retardation during the incidence of light having the wavelength λ from the direction orthogonal to the tilt alignment direction of the liquid crystal compound is preferably 0.24λ to 0.26λ, the absolute value of the ellipticity of the right circularly polarized light MR transmitted through the beam combiner element 60 can be suitably adjusted to be 0.8 or more.

On the other hand, as shown in FIG. 4, the O-plate 62bO is disposed on the optical path of the right circularly polarized light MR of parallel light that is not focused by the light control element 58. As described above, in the O-plate 62bO, the liquid crystal compound is tilted and aligned at an angle of +45° with respect to the main surface.

The right circularly polarized light MR that travels on the optical path where the light control element 58 is not disposed is parallel light, and is incident into the reflecting surface of the beam combiner element 60 at the same angle (45°) over the entire region in the direction orthogonal to the optical axis. That is, the change in polarization by the beam combiner element 60 is the same over the entire region in the direction orthogonal to the optical axis.

Likewise, as shown in FIG. 4, the right circularly polarized light MR that travels on the optical path where the light control element 58 is not disposed is incident into the O-plate 62bO at the same angle over the entire region in the direction orthogonal to the optical axis. That is, the right circularly polarized light MR that travels on the path where the light control element 58 is not disposed transmits through the O-plate 62bO at the same angle (+45°) with respect to the tilt alignment direction of the liquid crystal compound of the O-plate 62bO over the entire region in the direction orthogonal to the optical axis. That is, regarding the right circularly polarized light MR that travels on the path where the light control element 58 is not disposed, the change in polarization by the O-plate 62bO is the same over the entire region in the direction orthogonal to the optical axis.

By disposing the O-plate 62bO on the optical path, the absolute value of the ellipticity of the right circularly polarized light MR transmitted through the beam combiner element 60 without being focused by the light control element 58 can be adjusted to be 0.8 or more by the compensation of polarization by the O-plate 62bO.

In particular, in the O-plate 62bO, in a case where a retardation during vertical incidence of light having the wavelength λ with respect to the tilt alignment direction of the liquid crystal compound is preferably 0.24λ to 0.26λ, the left circularly polarized light ML transmitted through the beam combiner element 60 can be suitably adjusted to appropriate circularly polarized light.

In a preferable aspect, the beam combiner 50 in the example shown in the drawing includes the polarization compensating element that is provided on both of the optical path of the right circularly polarized light MR where the light control element 58 is provided and the optical path of the right circularly polarized light MR where the light control element 58 is not provided. However, the present invention is not limited to this example, and various configurations can be used.

Accordingly, the beam combiner according to the embodiment of the present invention may be configured to include only one of the polarization compensating elements 62a and 62b or may be configured not to include the polarization compensating element.

Note that in the beam combiner according to the embodiment of the present invention, it is preferable that the polarization compensating element is provided on at least the optical path where the light control element 58 is provided.

Accordingly, it is preferable that the beam combiner 50 in the example shown in the drawing includes at least the polarization compensating element 62a. In addition, as described above, in a case where the light control element 58 is disposed on both of the optical paths of light incident into the beam combiner element 60, it is preferable that the polarization compensating element is provided on both of the optical paths of light incident into the beam combiner element 60.

However, even in a case where the light control element 58 is provided on any one of the optical paths of light incident into the beam combiner element 60, it is also more preferable that the polarization compensating element is provided on both of the optical paths as in the example shown in the drawing.

Here, in the configuration where the light control element 58 is disposed on both of the optical paths of light incident into the beam combiner element 60, in a case where the O-plate is used as the polarization compensating element, it is preferable that the O-plate 62aO is provided on both of the optical paths such that the tilt alignment direction of the liquid crystal compound is tilted by −45° with respect to the main surface.

That is, the O-plate 62aO where the tilt alignment direction of the liquid crystal compound is tilted by −45° with respect to the main surface is the first O-plate according to the embodiment of the present invention and suitably corresponds to the optical path where the light control element 58 is provided. On the other hand, the O-plate 62bO where the tilt alignment direction of the liquid crystal compound is tilted by 45° with respect to the main surface is the second O-plate according to the embodiment of the present invention and suitably corresponds to the optical path where the light control element 58 is not provided.

As described above, in the beam combiner 50, as the angle at which the right circularly polarized light MR transmits through the light control element 58 and is incident into the photosensitive material Z increases, a fine interference pattern can be formed.

In the beam combiner 50 according to the embodiment of the present invention, an angle at which light transmits through the light control element 58 and is emitted from the beam combiner element 60 with respect to the optical axis of the light is not limited.

Here, it is preferable that, in a case where parallel light as the light transmitted through the light control element 58 (in the example shown in the drawing, the right circularly polarized light MR) is incident into the light control element 58, at least a part of the light emitted from the beam combiner element 60 has an angle of 15° or more with respect to an optical axis.

The angle of the light emitted from the beam combiner element 60 with respect to the optical axis is more preferably 17° or more and still more preferably 20° or more.

With the configuration in which at least a part of the light emitted from the beam combiner element 60 has an angle of 15° or more with respect to the optical axis, a fine interference pattern can be formed. In particular, in a case where the light (in the example shown in the drawing, the left circularly polarized light ML) that does not transmit through the light control element 58 is parallel light, a fine interference pattern can be suitably formed.

In the beam combiner according to the embodiment of the present invention, the polarization separating element separates incidence light into two right circularly polarized light components or two left circularly polarized light components.

That is, in the beam combiner according to the embodiment of the present invention, various configurations can be used as long as circularly polarized light components having the same turning direction can be incident into the first surface 60a and the second surface 60b of the beam combiner element 60.

FIG. 15 conceptually shows an example of the beam combiner.

In the following example, the same members as those of the beam combiner shown in FIG. 1 are widely used. Therefore, the same members are represented by the same reference numerals, and different points will be mainly described below.

In the beam combiner shown in FIG. 15, the polarization conversion element 68b is disposed immediately downstream of the beam splitter element 64, and a reflective member 69 including a cholesteric liquid crystal layer that selectively reflects the right circularly polarized light MR is provided instead of the mirror 56b.

In the present example, the beam splitter element 64, the polarization conversion elements 68a and 68b, the reflective member 69, and the mirror 56a correspond to the polarization separating element according to the embodiment of the present invention. In addition, among the polarization conversion element 68a and the mirror 56a, and the polarization conversion element 68b and the reflective member 69, one corresponds to the first polarization conversion element according to the embodiment of the present invention, and the other one corresponds to the second polarization conversion element according to the embodiment of the present invention.

In this beam combiner, the light M emitted from the light source 52 is separated into S-polarized light and P-polarized light by the beam splitter element 64 as described above.

As described above, the S-polarized light that travels on the optical path in the transverse direction in the drawing is converted into the left circularly polarized light ML by the polarization conversion element 68a, and is subsequently reflected from the mirror 56a to be converted into the right circularly polarized light MR. The right circularly polarized light MR reflected from the mirror 56a is focused by the light control element 58, the polarization state is adjusted by the polarization compensating element 62a, and the right circularly polarized light MR is incident into the first surface 60a of the beam combiner element 60.

On the other hand, the P-polarized light that travels on the optical path downward in the drawing is converted into the right circularly polarized light MR by the polarization conversion element 68b, and the right circularly polarized light MR is incident into the reflective member 69.

The reflective member 69 includes a cholesteric liquid crystal layer that selectively reflects right circularly polarized light. As is well known, the cholesteric liquid crystal layer obtained by immobilizing a cholesteric liquid crystal phase selectively reflects specific circularly polarized light having a specific wavelength, and transmits the other light. The transmitted light is circularly polarized light having a turning direction opposite to that of reflected light.

Accordingly, the right circularly polarized light MR incident into the reflective member 69 is reflected as it is. The polarization state of the right circularly polarized light MR reflected from the reflective member 69 is adjusted by the polarization compensating element 62b, and the right circularly polarized light MR is incident into the second surface 60b of the beam combiner element 60.

As described above, the right circularly polarized light MR incident into the first surface 60a of the beam combiner element 60 transmits through the beam combiner element as it is. On the other hand, the right circularly polarized light MR incident into the second surface 60b of the beam combiner element 60 is reflected from the second surface 60b to be converted into the left circularly polarized light ML.

The right circularly polarized light MR transmitted through the first surface 60a of the beam combiner element 60 and the left circularly polarized light ML reflected from the second surface 60b of the beam combiner element 60 are combined to interfere with each other, and the photosensitive material Z is exposed to the interference light.

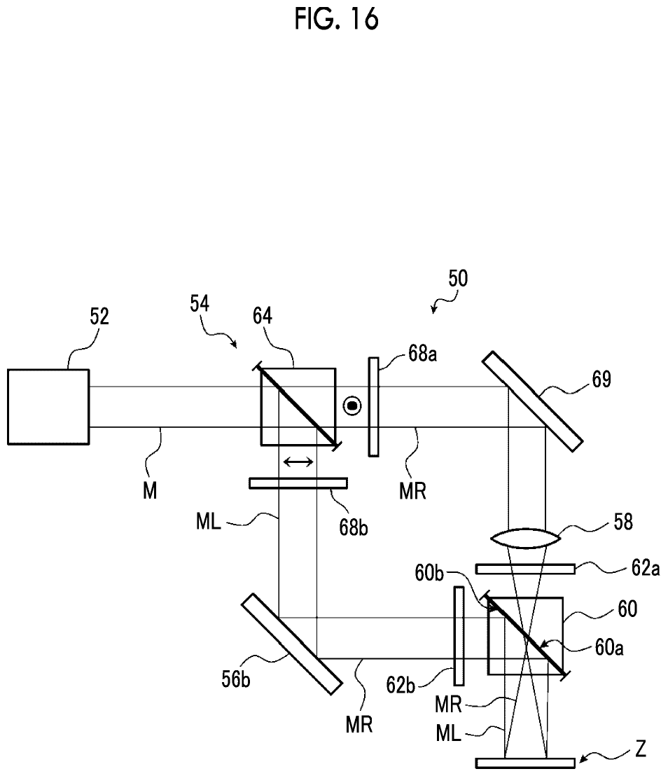

In this configuration, as conceptually shown in FIG. 16, the reflective member 69 including a cholesteric liquid crystal layer that selectively reflects the right circularly polarized light MR is provided instead of the mirror 56a of the optical path where the light control element 58 is provided.

In addition, in the example shown in FIG. 16, the direction of the slow axis is set such that the polarization conversion element 68a converts the S-polarized light into the right circularly polarized light MR and the polarization conversion element 68b converts the P-polarized light into the left circularly polarized light ML, respectively.

In this beam combiner, the light M emitted from the light source 52 is separated into S-polarized light and P-polarized light by the beam splitter element 64 as described above.

The S-polarized light that travels on the optical path in the transverse direction in the drawing is converted into the right circularly polarized light MR by the polarization conversion element 68a, and subsequently the right circularly polarized light MR is incident into the reflective member 69. As described above, the reflective member 69 includes a cholesteric liquid crystal layer that selectively reflects right circularly polarized light. Accordingly, the right circularly polarized light MR incident into the reflective member 69 is reflected as it is. The right circularly polarized light MR reflected from the reflective member 69 is focused by the light control element 58, the polarization state is adjusted by the polarization compensating element 62a, and the right circularly polarized light MR is incident into the first surface 60a of the beam combiner element 60.

On the other hand, the P-polarized light that travels on the optical path downward in the drawing is converted into the left circularly polarized light ML by the polarization conversion element 68b, and the left circularly polarized light ML is reflected from the mirror 56b to be converted into the right circularly polarized light MR. The polarization state of the right circularly polarized light MR reflected from the mirror 56b is adjusted by the polarization compensating element 62b, and the right circularly polarized light MR is incident into the second surface 60b of the beam combiner element 60.

In addition, the right circularly polarized light MR is reflected from the second surface 60b of the beam combiner element 60 to be converted into the left circularly polarized light ML.

As a result, as described above, the right circularly polarized light MR transmitted through the first surface 60a of the beam combiner element 60 and the left circularly polarized light ML reflected from the second surface 60b of the beam combiner element 60 interfere with each other, and the photosensitive material Z is exposed to the interference light.

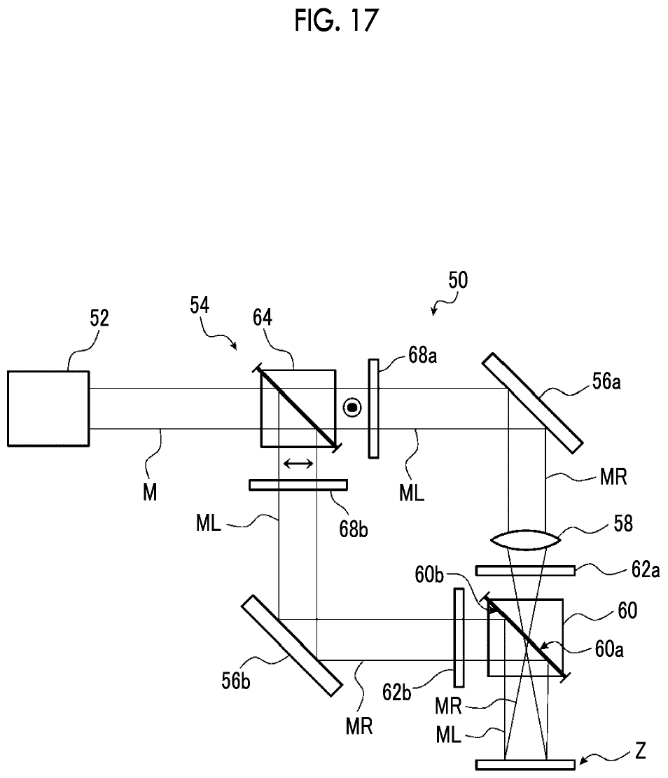

FIG. 17 illustrates another example of the beam combiner according to the embodiment of the present invention.

This beam combiner also includes the polarization conversion element 68b that is provided immediately below the beam splitter element 64. The polarization conversion element 68b sets the direction of the slow axis to convert the P-polarized light into the left circularly polarized light ML.

In the present example, the beam splitter element 64, the polarization conversion elements 68a and 68b, and the mirrors 56a and 56b correspond to the polarization separating element according to the embodiment of the present invention. Among the polarization conversion element 68a and the mirror 56a and the polarization conversion element 68b and the mirror 56b, one corresponds to the first polarization conversion element according to the embodiment of the present invention, the other one corresponds to the second polarization conversion element according to the embodiment of the present invention.

In this beam combiner, the light M emitted from the light source 52 is separated into S-polarized light and P-polarized light by the beam splitter element 64 as described above.

As described above, the S-polarized light that travels on the optical path in the transverse direction in the drawing is converted into the left circularly polarized light ML by the polarization conversion element 68a, and is subsequently reflected from the mirror 56a to be converted into the right circularly polarized light MR. The right circularly polarized light MR is focused by the light control element 58, the polarization state is adjusted by the polarization compensating element 62a, and the right circularly polarized light MR is incident into the first surface 60a of the beam combiner element 60.

On the other hand, the P-polarized light that travels on the optical path downward in the drawing is converted into the left circularly polarized light ML by the polarization conversion element 68b, and subsequently the left circularly polarized light ML is reflected from the mirror 56b to be converted into the right circularly polarized light MR. The polarization state of the right circularly polarized light MR is adjusted by the polarization compensating element 62b, and the right circularly polarized light MR is incident into the second surface 60b of the beam combiner element 60. In addition, the right circularly polarized light MR is reflected from the second surface 60b to be converted into the left circularly polarized light ML.

As a result, as described above, the right circularly polarized light MR transmitted through the first surface 60a of the beam combiner element 60 and the left circularly polarized light ML reflected from the second surface 60b of the beam combiner element 60 interfere with each other, and the photosensitive material Z is exposed to the interference light.

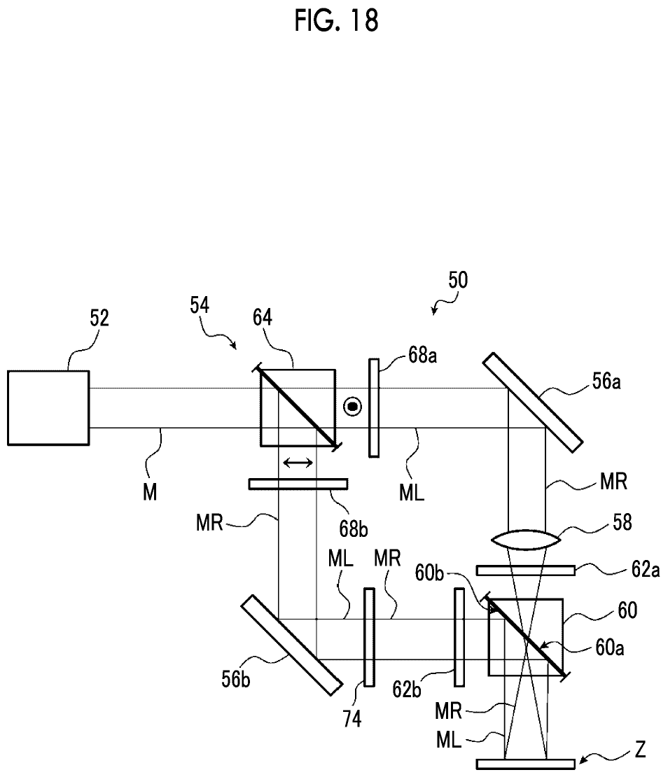

FIG. 18 illustrates another example of the beam combiner according to the embodiment of the present invention.

This beam combiner also includes the polarization conversion element 68b that is provided immediately below the beam splitter element 64, and a ½ wave plate 74 is further disposed between the mirror 56b and the polarization compensating element 62b.

In the present example, the beam splitter element 64, the polarization conversion elements 68a and 68b, the mirrors 56a and 56b, and the ½ wave plate 74 correspond to the polarization separating element according to the embodiment of the present invention. Among the polarization conversion element 68a and the mirror 56a and the polarization conversion element 68b, the mirror 56b, and the ½ wave plate 74, one corresponds to the first polarization conversion element according to the embodiment of the present invention, the other one corresponds to the second polarization conversion element according to the embodiment of the present invention.

In this beam combiner, the light M emitted from the light source 52 is separated into S-polarized light and P-polarized light by the beam splitter element 64 as described above.

As described above, the S-polarized light that travels on the optical path in the transverse direction in the drawing is converted into the left circularly polarized light ML by the polarization conversion element 68a, and is subsequently reflected from the mirror 56a to be converted into the right circularly polarized light MR. The right circularly polarized light MR reflected from the mirror 56a is focused by the light control element 58, the polarization state is adjusted by the polarization compensating element 62a, and the right circularly polarized light MR is incident into the first surface 60a of the beam combiner element 60.

On the other hand, the P-polarized light that travels on the optical path downward in the drawing is converted into the right circularly polarized light MR by the polarization conversion element 68b, and subsequently the right circularly polarized light MR is reflected from the mirror 56b to be converted into the left circularly polarized light ML.

The left circularly polarized light ML that is converted by being reflected from the mirror 56b is subsequently incident into and transmits through the ½ wave plate 74 such that the turning direction is reversed and the left circularly polarized light ML is converted into the right circularly polarized light MR.

The polarization state of the right circularly polarized light MR transmitted through the ½ wave plate 74 is adjusted by the polarization compensating element 62b, and the right circularly polarized light MR is incident into the second surface 60b of the beam combiner element 60. In addition, the right circularly polarized light MR is reflected from the second surface 60b to be converted into the left circularly polarized light ML.

As a result, as described above, the right circularly polarized light MR transmitted through the first surface 60a of the beam combiner element 60 and the left circularly polarized light ML reflected from the second surface 60b of the beam combiner element 60 interfere with each other, and the photosensitive material Z is exposed to the interference light.

In the beam combiner 50 shown in FIG. 1 or the like, the light M emitted from the light source 52 is directly incident into the polarization separating element 54, but the present invention is not limited thereto.

That is, the beam combiner according to the embodiment of the present invention may include various members for adjusting the light M emitted from the light source 52.

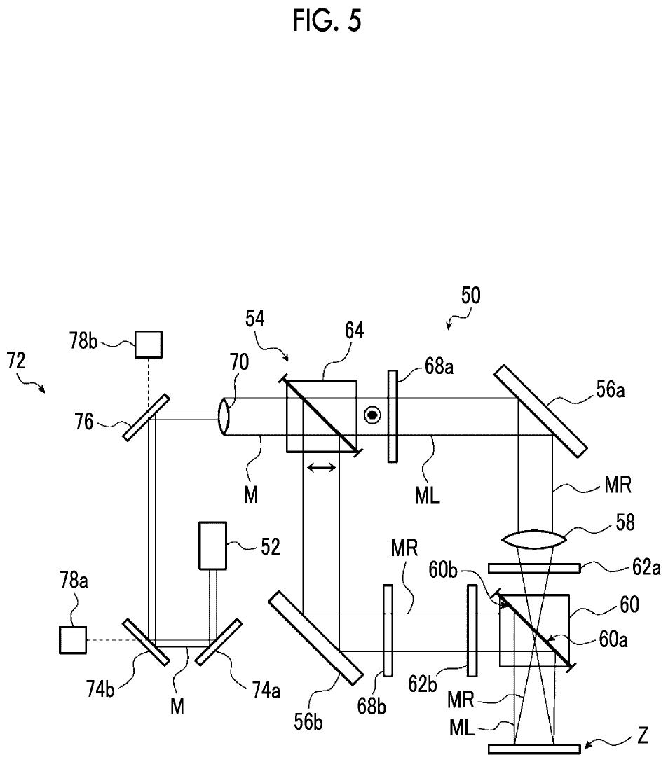

FIG. 5 shows an example of this beam combiner.

In the example shown in FIG. 5, as a preferable aspect, a beam expander element 70 and an optical path adjustment optical system 72 are provided between the light source 52 and the polarization separating element 54.

In the beam combiner according to the embodiment of the present invention, both of the beam expander element 70 and the optical path adjustment optical system 72 provided as the preferable aspect are not necessarily provided, and only either one thereof may be provided.

However, in the present invention, it is more preferable that both of the beam expander element 70 and the optical path adjustment optical system 72 are provided.

The beam expander element 70 expands the diameter of the light M (light beam) (beam expansion element).

The beam combiner includes the beam expander element 70 such that the area of an exposed region in the photosensitive material Z increases, and this configuration can also suitably deal with manufacturing of a large diffraction element (liquid crystal diffractive lens) or the like).

The beam expander element 70 is not limited, and various well-known beam expanders such as a Keplerian beam expander or a Galilean beam expander can be used as long as they can expand the light M that is linearly polarized light and has coherence.

In the exposure system according to the embodiment of the present invention, the position of the beam expander element 70 is not limited to a position between the light source 52 and the polarization separating element 54.

For example, the beam expander element 70 may be disposed on the optical path of the right circularly polarized light MR and the optical path of the left circularly polarized light ML between the polarization separating element 54 and the beam combiner element 60. Note that, in this case, the beam expander element 70 is disposed upstream of the light control element 58. Regarding this point, the same is also applicable to a case where the light control element is provided on the optical path of the left circularly polarized light ML.

In addition, in the exposure system according to the embodiment of the present invention, a plurality of the beam expander elements 70 may be disposed on one optical path. For example, the beam expander element 70 may be disposed upstream and downstream of the polarization separating element 54.

In the example shown in FIG. 5, the optical path adjustment optical system 72 is provided between the light source 52 and the beam expander element 70. The optical path adjustment optical system 72 is an optical system that detects the light M emitted from the light source 52 and appropriately adjusts the optical path (optical axis) of the light M.

In the example shown in the drawing, the optical path adjustment optical system 72 includes the actuated mirrors 74a and 74b, the mirror 76, and the detectors 78a and 78b.

The actuated mirrors 74a and 74b are well-known angle-variable mirrors where the angle can be adjusted by an actuator such as a piezoelectric element.

The detector 78a is a detector that detects an incidence position of the light M into the actuated mirror 74a. The detector 78b is a detector that detects an incidence position of the light M into the mirror 76. As a method of detecting the light M using the detectors 78a and 78b, various well-known methods such as a method measuring a small amount of light transmitted through a mirror using a photoconductive cell, a photodiode, or a photodetector of a phototube can be used.

The mirror 76 is a well-known reflecting mirror.

During the exposure of the photosensitive material Z, the optical path adjustment optical system 72 detects the incidence position of the light M on the actuated mirror 74a using the detector 78a and detects the incidence position of the light M on the mirror 76 using the detector 78b.

Based on the detection results of the light M, the optical path adjustment optical system 72 adjusts the angles of the actuated mirrors 74a and 74b such that the optical path of the light M from the light source 52 to the beam expander element 70 is appropriate.

Not only in the beam combiner but also in various optical systems, the light source 52 varies over time such that the optical path of the light M also deviates.

As a result, the incidence position of interference light into the photosensitive material Z deviates such that the exposure position on the photosensitive material Z is different from a desired position. In addition, the deviation in the optical path of the light beam M is the deviation in the incidence position and the angle of the light M into each of the optical elements. In a case where the deviation of the incidence position and the incidence angle into the optical element occurs, each of the optical elements cannot exhibit predetermined optical performance, and the exposure accuracy of the photosensitive material Z decreases.

On the other hand, as a preferable aspect, the beam combiner shown in FIG. 5 includes the optical path adjustment optical system 72 that adjusts the optical path of the light M. Thus, the photosensitive material Z can be exposed in a state where the optical path of the light M is at an appropriate position. As a result, in the beam combiner, high-accuracy exposure can be performed at the desired position of the photosensitive material Z.

In the exposure system according to the embodiment of the present invention, the optical path adjustment optical system is not limited to the configuration in the example shown in the drawing, and various well-known automatic adjustment units that adjust an optical path of a light beam used in various optical systems (optical devices) can be used.

A method of forming an alignment film according to the embodiment of the present invention comprises irradiating a coating film including a compound having a photo-aligned group with interference light generated by the beam combiner according to the embodiment of the present invention to form an alignment film.

In the method of forming an alignment film according to the embodiment of the present invention, that is, in the method of forming an alignment film according to the embodiment of the present invention using the beam combiner according to the embodiment of the present invention, a coating film including a compound having a photo-aligned group can be irradiated with an alignment pattern (interference pattern) having a large size, that is, interference light.

Accordingly, in a method of manufacturing an optical element described below using the alignment film formed using the method of forming an alignment film according to the embodiment of the present invention, an optical element having a large size, for example, up to a diameter of 70 mm can be prepared.

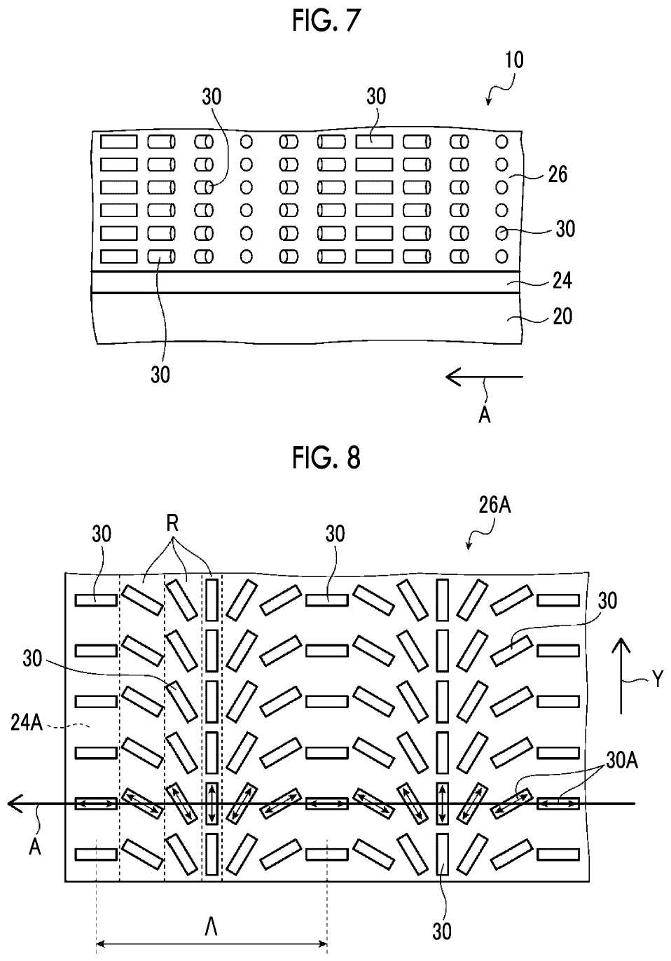

In the method of forming an alignment film according to the embodiment of the present invention, for example, as conceptually shown in FIG. 7, a method of forming an alignment film 24 consisting of a photo-alignment film on a support 20 can be used.

As the support 20, various sheet-shaped materials (films or plate-shaped materials) can be used as long as they can support the alignment film 24 and an optically-anisotropic layer 26 described below.

As the support 20, a transparent support is preferable, and examples thereof include a polyacrylic resin film such as polymethyl methacrylate, a cellulose resin film such as cellulose triacetate, a cycloolefin polymer film (for example, trade name “ARTON”, manufactured by JSR Corporation; or trade name “ZEONOR”, manufactured by Zeon Corporation), polyethylene terephthalate (PET), polycarbonate, and polyvinyl chloride. The support is not limited to a flexible film and may be a non-flexible substrate such as a glass substrate.

A coating film including a compound having a photo-aligned group is formed on a surface of the support 20, and this coating film is dried.

Next, the dried coating film is irradiated with interference light that is formed by the above-described beam combiner 50 according to the embodiment of the present invention and where the right circularly polarized light MR and the left circularly polarized light ML of circularly polarized light are combined. As a result, the interference pattern is formed on the coating film, and the alignment film 24 having the alignment pattern is formed.

For example, in a case where the light control element 58 is a convex lens as in the example shown in the drawing, as shown in FIG. 2, the alignment film 24 having the same alignment pattern as the concentric interference pattern that includes the pattern where the short line (short straight line) changes while continuously rotating in one direction in a radial shape can be formed.

Preferable examples of the compound having a photo-aligned group that is, the photo-alignment material used in the photo-alignment film that can be used in the present invention include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking ester described in JP2003-520878A, JP2004-529220A, and JP4162850B; and a photodimerizable compound, in particular, a cinnamate (cinnamic acid) compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking ester, a cinnamate compound, or a chalcone compound is suitably used.

Preferable examples of the compound having a photo-aligned group, that is, a photo-alignment material used for a photo-alignment film include a compound having an azobenzene group.

A thickness of the alignment film is not particularly limited. The thickness with which required alignment performance can be exhibited may be appropriately set depending on the material for forming the alignment film.

For example, in a case where azobenzene is used as the photo-alignment material to form a photo-alignment film, the thickness is preferably 50 to 100 nm.

In the method of manufacturing an optical element according to the embodiment of the present invention, a composition including a liquid crystal compound is applied to the alignment film formed as described above and is dried, and the liquid crystal compound is optionally cured.

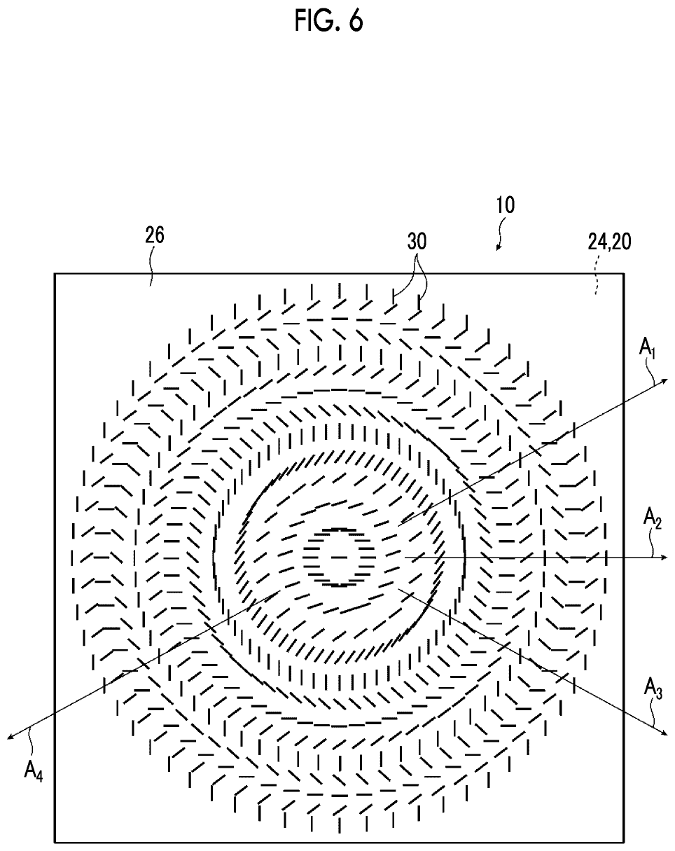

FIGS. 6 and 7 conceptually show an example of the optical element manufactured using the method of manufacturing an optical element according to the embodiment of the present invention. FIG. 6 is a plan view conceptually showing the optical element, and FIG. 7 is a cross-sectional view conceptually showing the optical element. The plan view is a view in a case where the optical element is seen from a thickness direction (laminating direction of the respective layers (films)).

As described above, the alignment film 24 is formed on the support 20. The optical element 10 shown in FIGS. 6 and 7 includes the optically-anisotropic layer 26 that is formed on the alignment film 24 using the composition including a liquid crystal compound.

For example, as described above, the alignment film 24 includes the concentric alignment pattern including the interference pattern where the orientation of the short line changes while continuously rotating in one direction in a radial shape from the inner side toward the outer side.

The optically-anisotropic layer 26 that is formed on the alignment film 24 using the composition including a liquid crystal compound includes a liquid crystal alignment pattern where an orientation of an optical axis derived from a liquid crystal compound 30 changes while continuously rotating in one direction in a radial shape from an inner side toward an outer side. That is, the liquid crystal alignment pattern in the optically-anisotropic layer 26 shown in FIGS. 6 and 7 is a concentric pattern including the one direction in which the orientation of the optical axis derived from the liquid crystal compound 30 changes while continuously rotating in a radial shape from the inner side toward the outer side.

In FIGS. 6 to 10, for example, a rod-like liquid crystal compound is used as the liquid crystal compound 30. Therefore, the direction of the optical axis matches with a longitudinal direction of the liquid crystal compound 30.

In the optically-anisotropic layer 26, the orientation of the optical axis of the liquid crystal compound 30 changes while continuously rotating in a plurality of directions from the center toward the outer side of the optically-anisotropic layer 26, for example, a direction indicated by an arrow A₁, a direction indicated by an arrow A₂, a direction indicated by an arrow A₃, a direction indicated by an arrow A₄, or . . .

Accordingly, in the optically-anisotropic layer 26, the rotation direction of the optical axis of the liquid crystal compound 30 is the same as all the directions (one direction). In the example shown in the drawing, in all the directions including the direction indicated by the arrow A₁, the direction indicated by the arrow A₂, the direction indicated by the arrow A₃, and the direction indicated by the arrow A₄, the rotation direction of the optical axis of the liquid crystal compound 30 is counterclockwise.

That is, in a case where the arrow A₁ and the arrow A₄ are assumed as one straight line, the rotation direction of the optical axis of the liquid crystal compound 30 is reversed at the center of the optically-anisotropic layer 26 on the straight line. For example, the straight line formed by the arrow A₁ and the arrow A₄ is directed in the right direction (arrow A₁ direction) in the drawing. In this case, the optical axis of the liquid crystal compound 30 initially rotates clockwise from the outer side to the center of the optically-anisotropic layer 26, the rotation direction is reversed at the center of the optically-anisotropic layer 26, and then the optical axis of the liquid crystal compound 30 rotates counterclockwise from the center to the outer side of the optically-anisotropic layer 26.

In addition, in the optically-anisotropic layer 26 of the optical element 10, in the liquid crystal alignment pattern, in a case where a length over which the orientation of the optical axis derived from the liquid crystal compound rotates by 180° in the one direction in which the orientation of the optical axis derived from the liquid crystal compound 30 changes while continuously rotating is set as a single period, the length of the single period gradually decreases from the inner side toward the outer side.

In circularly polarized light incident into the optically-anisotropic layer 26 having the above-described liquid crystal alignment pattern, an absolute phase changes depending on individual local regions having different orientations of optical axes of the liquid crystal compound 30. In this case, the amount of change in absolute phase in each of the local regions varies depending on the orientations of the optical axes of the liquid crystal compound 30 into which circularly polarized light is incident.

In the optically-anisotropic layer (optical element 10) having the liquid crystal alignment pattern in which the orientation of the optical axis of the liquid crystal compound 30 changes while continuously rotating in the one direction, a refraction direction of transmitted light depends on the rotation direction of the optical axis of the liquid crystal compound 30. That is, in this liquid crystal alignment pattern, in a case where the rotation direction of the optical axis of the liquid crystal compound 30 is reversed, the refraction direction of transmitted light is also reversed with respect to the one direction in which the optical axis rotates.

In addition, the diffraction angle of the optically-anisotropic layer 26 increases as the single period decreases. That is, the refraction of light of the optically-anisotropic layer 26 increases as the single period decreases.

Accordingly, in the optically-anisotropic layer 26 having the concentric liquid crystal alignment pattern, that is, the liquid crystal alignment pattern in which the optical axis changes while continuously rotating in a radial shape, incidence light (light beam) can be diffused or be focused and transmitted depending on the rotation direction of the optical axis of the liquid crystal compound 30 and the turning direction of circularly polarized light to be incident.

The optically-anisotropic layer 26 is formed of a composition including a liquid crystal compound.

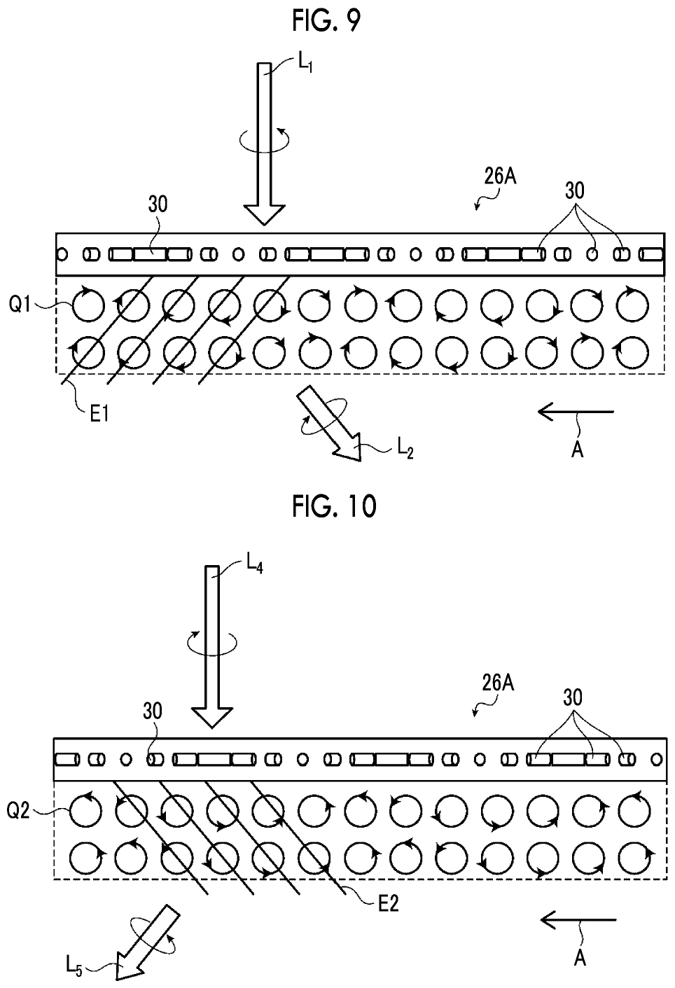

In FIG. 6, in order to simplify the drawing and to clarify the configuration of the optical element 10, only the liquid crystal compound 30 (liquid crystal compound molecules) on the surface of the alignment film 24 in the optically-anisotropic layer 26 is shown. However, as conceptually shown in FIG. 7, the first optically-anisotropic layer 26 has a structure in which the aligned liquid crystal compounds 30 are laminated as in an optically-anisotropic layer that is formed using a composition including a typical liquid crystal compound. Regarding this point, the same can also be applied to FIGS. 9 and 10 described below.

In a case where the value of in-plane retardation is set to λ/2, the optically-anisotropic layer 26 generally has a function as a λ/2 plate. That is, In a case where an in-plane retardation value is set as λ/2, the optically-anisotropic layer 26 has a function of imparting a retardation of a half wavelength, that is, 180° to two linearly polarized light components in light incident into the optically-anisotropic layer and are orthogonal to each other.

In a plane of the optically-anisotropic layer, the optically-anisotropic layer 26 includes the liquid crystal alignment pattern where the orientation of the optical axis derived from the liquid crystal compound changes while continuously rotating in one direction (for example, directions of the arrow A₁ to the arrow A₄ in FIG. 1) in a radial shape from the inner side toward the outer side.

The optical axis 30A derived from the liquid crystal compound 30 is an axis having the highest refractive index in the liquid crystal compound 30, that is, a so-called slow axis. For example, in a case where the liquid crystal compound 30 is a rod-like liquid crystal compound, the optical axis 30A is along a rod-like major axis direction.

In the following description, the optical axis 30A derived from the liquid crystal compound 30 will also be referred to as “the optical axis 30A of the liquid crystal compound 30” or “the optical axis 30A”.

Hereinafter, the optically-anisotropic layer 26 will be described with reference to an optically-anisotropic layer 26A that includes a liquid crystal alignment pattern where the optical axes 30A change while continuously rotating in one direction indicated by an arrow A as conceptually shown in a plan view of FIG. 8.

Even in the liquid crystal alignment pattern shown in FIG. 6 that includes one direction in which the optical axis changes while continuously rotating in a radial shape (concentric shape) from the inner side toward the outer side, the same optical effects as those of the liquid crystal alignment pattern shown in FIG. 8 can be exhibited for the one direction in which the optical axis changes while continuously rotating.

In the optically-anisotropic layer 26A, the liquid crystal compound 30 is two-dimensionally arranged in a plane parallel to the one direction indicated by the arrow A and a Y direction orthogonal to the arrow A direction. In FIGS. 9 and 10 described below, the Y direction is a direction orthogonal to the paper plane.

In the following description, “one direction indicated by the arrow A” will also be simply referred to as “arrow A direction”.

In the optically-anisotropic layer 26 shown in FIG. 6, a circumferential direction of a concentric circle in the concentric liquid crystal alignment pattern corresponds to the Y direction in FIG. 8.

The optically-anisotropic layer 26A has the liquid crystal alignment pattern in which the orientation of the optical axis 30A derived from the liquid crystal compound 30 changes while continuously rotating in the arrow A direction in a plane of the optically-anisotropic layer 26A.

Specifically, “the orientation of the optical axis 30A of the liquid crystal compound 30 changes while continuously rotating in the arrow A direction (the predetermined one direction)” represents that an angle between the optical axis 30A of the liquid crystal compound 30, which is arranged in the arrow A direction, and the arrow A direction varies depending on positions in the arrow A direction, and the angle between the optical axis 30A and the arrow A direction sequentially changes from θ to θ+180° or θ−180° in the arrow A direction.

A difference between the angles of the optical axes 30A of the liquid crystal compound 30 adjacent to each other in the arrow A direction is preferably 45° or less, more preferably 15° or less, and still more preferably less than 15°.

On the other hand, regarding the liquid crystal compound 30 forming the optically-anisotropic layer 26A, the liquid crystal compounds 30 having the same orientation of the optical axes 30A are arranged at regular intervals in the Y direction orthogonal to the arrow A direction, that is, the Y direction orthogonal to the one direction in which the optical axis 30A continuously rotates.

In other words, regarding the liquid crystal compound 30 forming the optically-anisotropic layer 26, in the liquid crystal compounds 30 arranged in the Y direction, angles between the orientations of the optical axes 30A and the arrow A direction are the same.

In the optically-anisotropic layer 26 shown in FIG. 6, a region where the orientations of the optical axes 30A are the same is formed in an annular shape where the centers match with each other.

As in the above-described short line, even in the optically-anisotropic layer 26, in the liquid crystal alignment pattern in which the optical axis 30A continuously rotates in the one direction, a length (distance) over which the optical axis 30A of the liquid crystal compound 30 rotates by 1800 is set as a length A of the single period in the liquid crystal alignment pattern.

That is, in the optically-anisotropic layer 26A shown in FIG. 8, the length (distance) over which the optical axis 30A of the liquid crystal compound 30 rotates by 180° in the arrow A direction in which the orientation of the optical axis 30A changes while continuously rotating in a plane is set as the single period Λ in the liquid crystal alignment pattern. In other words, the single period Λ in the liquid crystal alignment pattern is defined by the distance between θ and θ+180° that is a range of the angle between the optical axis 30A of the liquid crystal compound 30 and the arrow A direction.

That is, a distance between centers of two liquid crystal compounds 30 in the arrow A direction is the single period Λ, the two liquid crystal compounds having the same angle in the arrow A direction. Specifically, as shown in FIG. 8, a distance of centers in the arrow A direction of two liquid crystal compounds 30 in which the arrow A direction and the direction of the optical axis 30A match with each other is the single period Λ.

In the optically-anisotropic layer 26A (optically-anisotropic layer 26), in the liquid crystal alignment pattern of the optically-anisotropic layer, the single period Λ is repeated in the arrow A direction, that is, in the one direction in which the orientation of the optical axis 30A changes while continuously rotating.

In the optical element 10 having the liquid crystal alignment pattern where the optical axis 30A continuously rotates in a radial shape (concentric circular shape), the single period Λ in the optically-anisotropic layer 26 gradually decreases from the inner side (center) toward the outer side.

As described above, in the liquid crystal compounds arranged in the Y direction in the optically-anisotropic layer 26A, the angles between the optical axes 30A and the arrow A direction (the one direction in which the orientation of the optical axis of the liquid crystal compound 30 rotates) are the same. Regions where the liquid crystal compounds 30 in which the angles between the optical axes 30A and the arrow A direction are the same are disposed in the Y direction will be referred to as “regions R”.

In this case, it is preferable that an in-plane retardation (Re) value of each of the regions R is a half wavelength, that is, λ/2. The in-plane retardation is calculated from the product of a difference Δn in refractive index generated by refractive index anisotropy of the region R and the thickness of the optically-anisotropic layer. Here, the difference in refractive index generated by refractive index anisotropy of the region R in the optically-anisotropic layer is defined by a difference between a refractive index of a direction of an in-plane slow axis of the region R and a refractive index of a direction orthogonal to the direction of the slow axis. That is, the difference Δn in refractive index generated by refractive index anisotropy of the region R is the same as a difference between a refractive index of the liquid crystal compound 30 in the direction of the optical axis 30A and a refractive index of the liquid crystal compound 30 in a direction perpendicular to the optical axis 30A in a plane of the region R. That is, the difference Δn in refractive index is the same as the difference in refractive index of the liquid crystal compound.

In the optical element 10 having the liquid crystal alignment pattern where the optical axis 30A continuously rotates in the one direction in a radial shape, the region where the orientations of the optical axes 30A are the same that is formed in an annular shape where the centers match with each other corresponds to the region R in FIG. 8. Regarding this point, the same can also be applied to the reflective optical element 10 including a cholesteric liquid crystal layer described below.

In a case where circularly polarized light is incident into the above-described optically-anisotropic layer 26A, the light is refracted such that the direction of the circularly polarized light is converted.

This action is conceptually shown in FIGS. 9 and 10. In the optically-anisotropic layer 26A, the value of the product of the difference in refractive index of the liquid crystal compound and the thickness of the optically-anisotropic layer is λ/2.

As described above, this action is also completely the same in the optical element 10 having the liquid crystal alignment pattern where the optical axis 30A continuously rotates in the one direction in a radial shape.

As shown in FIG. 9, in a case where the value of the product of the difference in refractive index of the liquid crystal compound in the optically-anisotropic layer 26A and the thickness of the optically-anisotropic layer is λ/2 and incidence light L₁ as left circularly polarized light is incident into the optically-anisotropic layer 26A, the incidence light L₁ transmits through the optically-anisotropic layer 26A to be imparted with a retardation of 180°, and the transmitted light L₂ is converted into right circularly polarized light.

In addition, in a case where the incidence light L₁ transmits through the optically-anisotropic layer 26A, an absolute phase thereof changes depending on the orientation of the optical axis 30A of each of the liquid crystal compounds 30. In this case, the orientation of the optical axis 30A changes while rotating in the arrow A direction. Therefore, the amount of change in the absolute phase of the incidence light L₁ varies depending on the direction of the optical axis 30A. Further, the liquid crystal alignment pattern that is formed in the optically-anisotropic layer 26A is a pattern that is periodic in the arrow A direction. Therefore, as shown in FIG. 9, the incidence light L₁ transmitted through the optically-anisotropic layer 26A is imparted with an absolute phase Q1 that is periodic in the arrow A direction corresponding to the orientation of each of the optical axes 30A. As a result, an equiphase surface E1 that is tilted in a direction opposite to the arrow A direction is formed.

Therefore, the transmitted light L₂ is refracted (diffracted) to be tilted in a direction perpendicular to the equiphase surface E1 and travels in a direction different from a traveling direction of the incidence light L1. This way, the incidence light L₁ of the left circularly polarized light is converted into the transmitted light L₂ of right circularly polarized light that is tilted by a predetermined angle in the arrow A direction with respect to an incidence direction.

On the other hand, as conceptually shown in FIG. 10, in a case where the value of the product of the difference in refractive index of the liquid crystal compound in the optically-anisotropic layer 26A and the thickness of the optically-anisotropic layer is λ/2 and incidence light L₄ as right circularly polarized light is incident into the optically-anisotropic layer 26A, the incidence light L₄ transmits through the optically-anisotropic layer 26A to be imparted with a retardation of 180° and is converted into transmitted light L₅ of left circularly polarized light.

In addition, in a case where the incidence light L₄ transmits through the optically-anisotropic layer 26A, an absolute phase thereof changes depending on the orientation of the optical axis 30A of each of the liquid crystal compounds 30. In this case, the orientation of the optical axis 30A changes while rotating in the arrow A direction. Therefore, the amount of change in the absolute phase of the incidence light L₄ varies depending on the direction of the optical axis 30A. Further, the liquid crystal alignment pattern that is formed in the optically-anisotropic layer 26A is a pattern that is periodic in the arrow A direction. Therefore, as shown in FIG. 7, the incidence light L₄ transmitted through the optically-anisotropic layer 26A is imparted with an absolute phase Q2 that is periodic in the arrow A direction corresponding to the orientation of each of the optical axes 30A.

Here, the incidence light L₄ is right circularly polarized light. Therefore, the absolute phase Q2 that is periodic in the arrow A direction corresponding to the orientation of the optical axis 30A is opposite to the incidence light L₁ as left circularly polarized light. As a result, in the incidence light L₄, an equiphase surface E2 that is tilted in the arrow A direction opposite to that of the incidence light L₁ is formed.

Therefore, the incidence light L₄ is refracted to be tilted in a direction perpendicular to the equiphase surface E2 and travels in a direction different from a traveling direction of the incidence light L₄. This way, the incidence light L₄ is converted into the transmitted light L₅ of left circularly polarized light that is tilted by a predetermined angle in a direction opposite to the arrow A direction with respect to an incidence direction.

In the optically-anisotropic layer 26, it is preferable that the in-plane retardation value of the plurality of regions R is a half wavelength. It is preferable that an in-plane retardation Re(550)=Δn₅₅₀×d of the plurality of regions R of the optically-anisotropic layer 26 with respect to the incidence light having a wavelength of 550 nm is in a range defined by the following Expression (1). Here, Δn₅₅₀ represents a difference in refractive index generated by refractive index anisotropy of the region R in a case where the wavelength of incidence light is 550 nm, and d represents the thickness of the optically-anisotropic layer 26.

200 nm≤Δn₅₅₀×d≤350 nm (1).

The optically-anisotropic layer 26 functions as a so-called λ/2 plate. However, in the present invention, in a case where the support 20 and the alignment film 24 are provided, an aspect where a laminate integrally including the support 20 and the alignment film 24 functions as a λ/2 plate.

Here, by changing the single period Λ of the liquid crystal alignment pattern formed in the optically-anisotropic layer 26A, refraction angles of the transmitted light components L₂ and L₅ can be adjusted. Specifically, as the single period Λ of the liquid crystal alignment pattern decreases, light components transmitted through the liquid crystal compounds 30 adjacent to each other more strongly interfere with each other. Therefore, the transmitted light components L₂ and L₅ can be more largely refracted.

In addition, refraction angles of the transmitted light components L₂ and L₅ with respect to the incidence light components L₁ and L₄ vary depending on the wavelengths of the incidence light components L₁ and L₄ (the transmitted light components L₂ and L₅). Specifically, as the wavelength of incidence light increases, the transmitted light is largely refracted. That is, in a case where incidence light is red light, green light, and blue light, the red light is refracted to the highest degree, and the blue light is refracted to the lowest degree.

Further, by reversing the rotation direction of the optical axis 30A of the liquid crystal compound 30 that rotates in the arrow A direction, the refraction direction of transmitted light can be reversed.

As described above, in the optically-anisotropic layer 26 of the optical element 10, in the liquid crystal alignment pattern in which the optical axis 30A rotates in the one direction, the single period Λ of the liquid crystal alignment pattern gradually decreases from the inner side (center) toward the outer side.

Accordingly, depending on the wavelength, the polarization state, and the like of incident light, the rotation direction of the optical axis 30A from an inner side toward an outer side is set such that light is refracted from the center of the optical element 10, and the degree to which the length of the single period Λ of the liquid crystal alignment pattern gradually decreases is appropriately adjusted. As a result, the degree to which the light is focused toward the center (optical axis) of the optical element 10 can be adjusted.

That is, by increasing the degree to which the length of the single period Λ in the liquid crystal alignment pattern gradually decreases, the optical element 10 can act as a condenser lens (liquid crystal lens, liquid crystal diffractive lens). In addition, by decreasing the degree to which the length of the single period Λ in the liquid crystal alignment pattern gradually decreases, the optical element 10 can act as a collimating lens.

The optically-anisotropic layer 26 is formed of a liquid crystal composition including a rod-like liquid crystal compound or a disk-like liquid crystal compound, and has a liquid crystal alignment pattern in which an optical axis of the rod-like liquid crystal compound or an optical axis of the disk-like liquid crystal compound is aligned as described above.

By forming the alignment film 24 having the alignment pattern corresponding to the above-described liquid crystal alignment pattern on the support 20 and applying the liquid crystal composition to the alignment film 24, and curing the applied liquid crystal composition, the optically-anisotropic layer formed of the cured layer of the liquid crystal composition can be obtained.

In addition, the liquid crystal composition for forming the optically-anisotropic layer 26 includes a rod-like liquid crystal compound or a disk-like liquid crystal compound and may further include other components such as a leveling agent, an alignment control agent, a polymerization initiator, or an alignment assistant.

A method of curing the liquid crystal composition is not limited, and various well-known methods can be used depending on the liquid crystal compound to be cured. For example, a method using heating, a method using irradiation of light such as ultraviolet light, infrared light, or visible light, or a method using drying can be used. In particular, the curing of a liquid crystal composition by ultraviolet irradiation is suitably used.

In addition, it is preferable that the optically-anisotropic layer 26 has a wide range for the wavelength of incidence light and is formed of a liquid crystal material having a reverse birefringence index dispersion. In addition, it is also preferable that the optically-anisotropic layer can be made to have a substantially wide range for the wavelength of incidence light by imparting a twist component to the liquid crystal composition or by laminating different retardation layers. For example, in the optically-anisotropic layer 26, a method of realizing a λ/2 plate having a wide-range pattern by laminating two liquid crystal layers having different twisted directions is disclosed in, for example, JP2014-089476A and can be preferably used in the present invention.

### —Rod-Like Liquid Crystal Compound—

As the rod-like liquid crystal compound, an azomethine compound, an azoxy compound, a cyanobiphenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolan compound, or an alkenylcyclohexylbenzonitrile compound is preferably used. As the rod-like liquid crystal compound, not only the above-described low molecular weight liquid crystal molecules but also polymer liquid crystal molecules can be used.

In the optically-anisotropic layer 26, it is more preferable that the alignment of the rod-like liquid crystal compound is immobilized by polymerization. Examples of the polymerizable rod-like liquid crystal compound include compounds described in Makromol. Chem., (1989), Vol. 190, p. 2255, Advanced Materials (1993), Vol. 5, p. 107, U.S. Pat. Nos. 4,683,327A, 5,622,648A, 5,770,107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), and JP2001-64627. Further, as the rod-like liquid crystal compound, for example, compounds described in JP1999-513019A (JP-H11-513019A) and JP2007-279688A can also be preferably used.

### —Disk-Like Liquid Crystal Compound—

As the disk-like liquid crystal compound, for example, compounds described in JP2007-108732A and JP2010-244038A can be preferably used.

In a case where the disk-like liquid crystal compound is used in the optically-anisotropic layer, the liquid crystal compound 30 rises in the thickness direction in the optically-anisotropic layer, and the optical axis 30A derived from the liquid crystal compound is defined as an axis perpendicular to a disk plane, that is so-called, a fast axis.

The above-described optical element 10 is a transmissive optical element 10 through which circularly polarized light transmits and is diffracted. However, the optical element manufactured using the manufacturing method according to the embodiment of the present invention is not limited to this configuration.

That is, the optical element manufactured using the manufacturing method according to the embodiment of the present invention may be a reflective optical element including a cholesteric liquid crystal layer.

FIG. 11 conceptually shows an example of the reflective optical element manufactured using the manufacturing method according to the embodiment of the present invention. An optical element 36 shown in FIG. 11 includes a plurality of members that are the same as those in the above-described transmissive optical element 10 are used. Therefore, the same members are represented by the same reference numerals, and different portions will be mainly described below.

FIG. 11 is a diagram conceptually showing a layer configuration of the reflective optical element 36. The optical element 36 includes the support 20 and the alignment film 24 described above, and a cholesteric liquid crystal layer 34 that exhibits the action as the reflective optical element 36.

Regarding the liquid crystal alignment pattern of the liquid crystal compound 30 in the cholesteric liquid crystal layer 34, as in the optical element 10, as shown in FIG. 6, the liquid crystal alignment pattern in which the optical axis 30A changes while continuously rotating in the one direction indicated by the arrow A is provided in a radial shape.

FIG. 12 is a schematic diagram showing an alignment state of the liquid crystal compound 30 in a plane of a main surface of the cholesteric liquid crystal layer 34. FIG. 12 shows an alignment state of a facing surface of the cholesteric liquid crystal layer 34A facing the alignment film 24.

As in FIG. 8 described above, in the cholesteric liquid crystal layer 34A shown in FIG. 12, in order to describe the cholesteric liquid crystal layer 34, the liquid crystal alignment pattern in which the optical axis 30A changes while continuously rotating in the one direction indicated by the arrow A is shown. However, even in the liquid crystal alignment pattern that includes one direction in which the optical axis changes while continuously rotating in a radial shape (concentric shape) from an inner side toward an outer side, the same optical effects as those of the liquid crystal alignment pattern shown in FIG. 12 can be exhibited for the one direction in which the optical axis changes while continuously rotating.

In addition, as in FIG. 8 described above, even in FIG. 12, a circumferential direction of a concentric circle in the concentric liquid crystal alignment pattern shown in FIG. 6 corresponds to the Y direction in FIG. 12.

As shown in FIG. 11, the cholesteric liquid crystal layer 34 is a layer obtained by cholesteric alignment of the liquid crystal compound 30. In addition, FIGS. 11 and 12 show an example in which the liquid crystal compound forming the cholesteric liquid crystal layer is a rod-like liquid crystal compound.

In the following description, the cholesteric liquid crystal layer will also be referred to as the liquid crystal layer.

In the optical element 36, the support 20 and the alignment film 24 are as described above.

In the optical element 36, the liquid crystal layer 34 (cholesteric liquid crystal layer) having the liquid crystal alignment pattern shown in FIG. 6 is provided on the alignment film 24 having the alignment pattern shown in FIG. 2.

The liquid crystal layer 34 is a cholesteric liquid crystal layer obtained by cholesterically aligning the liquid crystal compound to immobilize a cholesteric liquid crystal phase. In the present example, the cholesteric liquid crystal layer has a liquid crystal alignment pattern in which an orientation of an optical axis derived from a liquid crystal compound changes while continuously rotating in at least one in-plane direction.

As conceptually shown in FIG. 11, the liquid crystal layer 34 has a helical structure in which the liquid crystal compound 30 is helically turned and laminated as in a cholesteric liquid crystal layer obtained by immobilizing a typical cholesteric liquid crystal phase. In the helical structure, a configuration in which the liquid crystal compound 30 is helically rotated once (rotated by 360°) and laminated is set as one helical pitch (helical pitch P), and plural pitches of the helically turned liquid crystal compound 30 are laminated.

As is well known, the cholesteric liquid crystal phase exhibits selective reflectivity with respect to left or right circularly polarized light at a specific wavelength. Whether or not the reflected light is right circularly polarized light or left circularly polarized light is determined depending on a helical twisted direction (sense) of the cholesteric liquid crystal phase.

Regarding the selective reflection of the circularly polarized light by the cholesteric liquid crystal phase, in a case where the helical twisted direction of the cholesteric liquid crystal phase is right, right circularly polarized light is reflected, and in a case where the helical twisted direction of the cholesteric liquid crystal phase is left, left circularly polarized light is reflected.

A turning direction of the cholesteric liquid crystal phase can be adjusted by adjusting the kind of the liquid crystal compound that forms the cholesteric liquid crystal layer and/or the kind of the chiral agent to be added.

In addition, a half-width A) (nm) of a selective reflection range (circularly polarized light reflection range) where selective reflection is exhibited depends on Δn of the cholesteric liquid crystal phase and the helical pitch P and satisfies a relationship of “Δλ=Δn×helical pitch”. Therefore, the width of the selective reflection range can be controlled by adjusting Δn. An can be adjusted by adjusting a kind of a liquid crystal compound for forming the cholesteric liquid crystal layer and a mixing ratio thereof, and a temperature during alignment immobilization.

Accordingly, regarding the wavelength of light that is reflected (diffracted) by the liquid crystal layer 34, the selective reflection wavelength range of the liquid crystal layer 34 may be appropriately set, for example, by adjusting the helical pitch P of the liquid crystal layer according to each of the liquid crystal diffraction elements.

As shown in FIG. 12, in the liquid crystal layer 34A, the liquid crystal compounds 30 are arranged in the arrow A direction and the Y direction orthogonal to the arrow A direction. The orientation of the optical axis 30A of the liquid crystal compound 30 changes while continuously rotating in the one in-plane direction in a plane, that is, in the arrow A direction. In addition, in the Y direction, the liquid crystal compounds 30 in which the orientations of the optical axes 30A are the same are arranged at regular intervals.

“The orientation of the optical axis 30A of the liquid crystal compound 30 changes while continuously rotating in the one in-plane direction” represents that as in the optically-anisotropic layer 26, angles between the optical axes 30A of the liquid crystal compounds 30 and the arrow A direction vary depending on positions in the arrow A direction and the angle between the optical axis 30A and the arrow A direction gradually changes from θ to θ+180° or θ−180° in the arrow A direction. That is, in each of the plurality of liquid crystal compounds 30 arranged in the arrow A direction, as shown in FIG. 12, the optical axis 30A changes in the arrow A direction while rotating on a given angle basis.

A difference between the angles of the optical axes 30A of the liquid crystal compound 30 adjacent to each other in the arrow A direction is preferably 45° or less, more preferably 15° or less, and still more preferably less than 15°.

As in the above-described optically-anisotropic layer 26, even in the liquid crystal layer 34, in the liquid crystal alignment pattern of the liquid crystal compound 30, a length (distance) over which the optical axis 30A of the liquid crystal compound 30 rotates by 1800 in the arrow A direction in which the optical axis 30A changes while continuously rotating in a plane is set as a length A of the single period in the liquid crystal alignment pattern.

In the liquid crystal alignment pattern of the liquid crystal layer 34A, the single period Λ is repeated in the arrow A direction, that is, in the one direction in which the orientation of the optical axis 30A changes while continuously rotating. The optical element 36 is a liquid crystal diffraction element, and the single period Λ is the period (single period) of the diffraction structure as described above.

On the other hand, in the liquid crystal compound 30 forming the liquid crystal layer 34A, the orientations of the optical axes 30A are the same in the direction (in FIG. 12, the Y direction) orthogonal to the arrow A direction, that is, the Y direction orthogonal to the one direction in which the optical axis 30A continuously rotates. In the liquid crystal alignment pattern shown in FIG. 6, as described above, the Y direction is a circumferential direction of a concentric circle.

In other words, in the liquid crystal compound 30 forming the liquid crystal layer 34, angles between the optical axes 30A of the liquid crystal compound 30 and the arrow A direction (X direction) are the same in the Y direction.

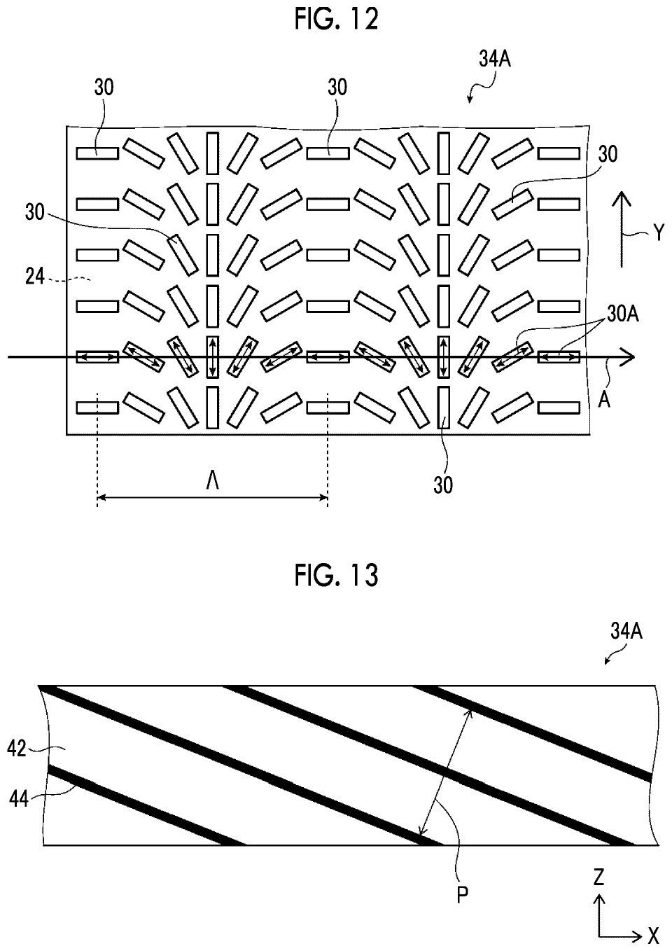

In a case where a cross section of the liquid crystal layer 34 shown in FIG. 11 in the X-Z direction is observed with a scanning electron microscope (SEM), an arrangement direction in which bright portions 42 and dark portions 44 are alternately arranged as shown in FIG. 13, a stripe pattern tilted at a predetermined angle with respect to the main surface (X-Y plane) is observed.

Basically, the interval of the bright portions 42 and the dark portions 44 depends on the helical pitch P of the cholesteric liquid crystal layer.

Accordingly, the wavelength range of light that is selectively reflected by the cholesteric liquid crystal layer correlates to the interval of the bright portions 42 and the dark portions 44. That is, as the interval of the bright portions 42 and the dark portions 44 increases, the helical pitch P increases. Therefore, the wavelength range of light that is selectively reflected by the cholesteric liquid crystal layer increases. Conversely, as the interval of the bright portions 42 and the dark portions 44 decreases, the helical pitch P decreases. Therefore, the wavelength range of light that is selectively reflected by the cholesteric liquid crystal layer decreases.

In the cholesteric liquid crystal layer, basically, a structure in which the bright portion 42 and the dark portion 44 are repeated twice corresponds to the helical pitch P. Accordingly, in the cross section observed with an SEM, an interval between the bright portions 42 adjacent to each other or between the dark portions 44 adjacent to each other in a normal direction (vertical direction) of lines formed by the bright portions 42 or the dark portions 44 corresponds to a ½ pitch of the helical pitch P.

That is, the helical pitch P may be measured by setting the interval between the bright portions 42 or between the dark portions 44 in the normal direction with respect to the lines as a ½ pitch.

Hereinafter, an action of diffraction of the liquid crystal layer 34A will be described.

In a cholesteric liquid crystal layer of the related art, a helical axis derived from a cholesteric liquid crystal phase is perpendicular to the main surface, and a reflecting surface thereof is parallel to the main surface. In addition, the optical axis of the liquid crystal compound is not tilted with respect to the main surface. In other words, the optical axis is parallel to the main surface. Accordingly, in a case where the X-Z plane of the cholesteric liquid crystal layer in the related art is observed with an SEM, an arrangement direction in which bright portions and dark portions are alternately arranged is perpendicular to the main surface.

The cholesteric liquid crystal phase has specular reflectivity. Therefore, in a case where light is incident from the normal direction into the cholesteric liquid crystal layer, the light is reflected in the normal direction.

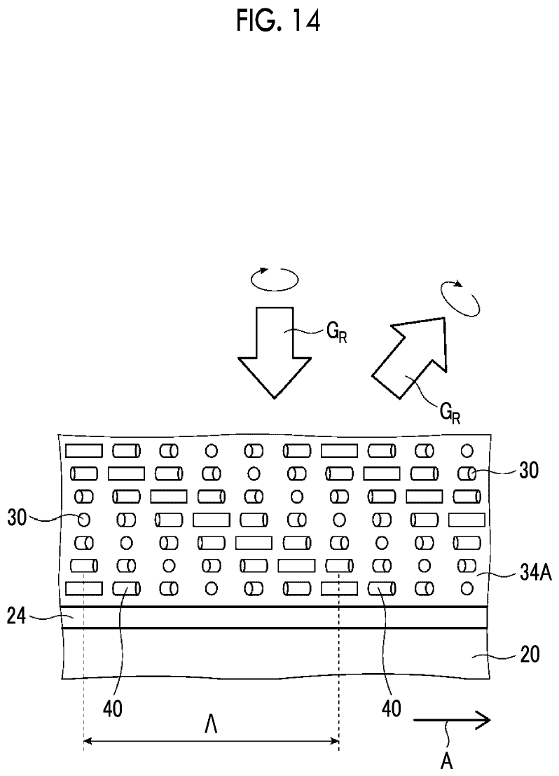

On the other hand, the liquid crystal layer 34A reflects incident light in a state where the light is tilted in the arrow A direction with respect to the specular reflection. The liquid crystal layer 34A has the liquid crystal alignment pattern in which the optical axis 30A changes while continuously rotating in the arrow A direction (the predetermined one direction) in a plane. Hereinafter, the description will be made with reference to FIG. 14.

For example, it is assumed that the liquid crystal layer 34A is a cholesteric liquid crystal layer that selectively reflects right circularly polarized light G_{R} of green light. Accordingly, in a case where light is incident into the liquid crystal layer 34A, the liquid crystal layer 34A reflects only right circularly polarized light G_{R} of green light and allows transmission of the other light.

Here, in the liquid crystal layer 34A, the optical axis 30A of the liquid crystal compound 30 changes while rotating in the arrow A direction (the one direction).

The liquid crystal alignment pattern formed in the liquid crystal layer 34A is a pattern that is periodic in the arrow A direction. Therefore, as conceptually shown in FIG. 14, the right circularly polarized light G_{R} of green light incident into the liquid crystal layer 34A is reflected (diffracted) in a direction corresponding to the period of the liquid crystal alignment pattern, and the reflected right circularly polarized light G_{R} of green light is reflected (diffracted) in a direction tilted with respect to the XY plane (the main surface of the cholesteric liquid crystal layer) in the arrow A direction.

In addition, in a case where circularly polarized light having the same wavelength and the same turning direction is reflected, by reversing the rotation direction of the optical axis 30A of the liquid crystal compound 30 toward the arrow A direction, a reflection direction of the circularly polarized light can be reversed.

That is, in FIGS. 11 and 12, the rotation direction of the optical axis 30A toward the arrow A direction is clockwise, and one circularly polarized light is reflected in a state where the light is tilted in the arrow A direction. By setting the rotation direction of the optical axis 30A to be counterclockwise, the circularly polarized light is reflected in a state where the light is tilted in a direction opposite to the arrow A direction.

Further, in the liquid crystal layer having the same liquid crystal alignment pattern, the reflection direction is reversed by adjusting the helical turning direction of the liquid crystal compound 30, that is, the turning direction of circularly polarized light to be reflected.

For example, in a case where the helical turning direction of the liquid crystal layer is right-twisted, the liquid crystal layer selectively reflects right circularly polarized light, and has the liquid crystal alignment pattern in which the optical axis 30A rotates clockwise in the arrow A direction. As a result, the right circularly polarized light is reflected in a state where the light is tilted in the arrow A direction.

In addition, for example, in a case where the helical turning direction of the liquid crystal layer is left-twisted, the liquid crystal layer selectively reflects left circularly polarized light, and has the liquid crystal alignment pattern in which the optical axis 30A rotates clockwise in the arrow A direction. As a result, the left circularly polarized light is reflected in a state where the light is tilted in a direction opposite to the arrow A direction.

Accordingly, the optical element 36 can be used as a convex mirror that reflects incidence light to diffuse the light or a concave mirror that reflects incidence light to focus the light depending on the rotation direction of the optical axis 30A from the inner side toward the outer side in the liquid crystal layer 34 and the turning direction of circularly polarized light to be selectively reflected from the liquid crystal layer 34.

As described above, in the liquid crystal layer 34 that acts as the reflective optical element 36, in the liquid crystal alignment pattern of the liquid crystal compound 30, the single period Λ as the length over which the optical axis 30A of the liquid crystal compound 30 rotates by 180° is the period (single period) of the diffraction structure. In addition, in the liquid crystal layer 34, the one direction (arrow A direction) in which the optical axis 30A of the liquid crystal compound 30 changes while rotating is the periodic direction of the diffraction structure.

In the liquid crystal layer having the liquid crystal alignment pattern, as the single period Λ decreases, the diffraction angle of reflected light with respect to the incidence light increases. That is, as the single period Λ decreases, incidence light can be largely diffracted to be reflected in a direction that is largely different from specular reflection.

In the present invention, the single period Λ of the liquid crystal layer 34 is not particularly limited, and the single period Λ from which signal light 103 to be assumed can be separated may be appropriately set depending on the wavelength or the like of the signal light 103.

The single period Λ of the liquid crystal layer 34 is preferably 0.1 to 20 μm and more preferably 0.1 to 10 μm.

The liquid crystal layer 34 can be formed by immobilizing a liquid crystal phase in a layer shape, the liquid crystal phase obtained by aligning the liquid crystal compound 30 in a predetermined alignment state. For example, the cholesteric liquid crystal layer can be formed by immobilizing a cholesteric liquid crystal phase in a layer shape.

The structure in which a cholesteric liquid crystal phase is immobilized may be a structure in which the alignment of the liquid crystal compound as a liquid crystal phase is immobilized. Typically, the structure in which a liquid crystal phase is immobilized is preferably a structure which is obtained by making the polymerizable liquid crystal compound to be in a state where a predetermined liquid crystal phase is aligned, polymerizing and curing the polymerizable liquid crystal compound with ultraviolet irradiation, heating, or the like to form a layer having no fluidity, and concurrently changing the state of the polymerizable liquid crystal compound into a state where the alignment state is not changed by an external field or an external force.

The structure in which a liquid crystal phase is immobilized is not particularly limited as long as the optical characteristics of the liquid crystal phase are maintained, and the liquid crystal compound 30 in the liquid crystal layer does not necessarily exhibit liquid crystallinity. For example, the molecular weight of the polymerizable liquid crystal compound may be increased by a curing reaction such that the liquid crystallinity thereof is lost.

Regarding this point, the same can also be applied to the above-described optically-anisotropic layer 26.

Examples of a material used for forming the liquid crystal layer 34 include a liquid crystal composition including a liquid crystal compound. It is preferable that the liquid crystal compound is a polymerizable liquid crystal compound.

Examples of the liquid crystal composition for forming the (cholesteric) liquid crystal layer 34 include a liquid crystal composition obtained by adding a chiral agent for helically aligning the liquid crystal compound 30 to the liquid crystal composition for forming the optically-anisotropic layer 26 of the above-described transmissive optical element 36.

### —Chiral Agent (Optically Active Compound)—

The chiral agent has a function of causing a helical structure of a cholesteric liquid crystal phase to be formed. The chiral agent may be selected depending on the purpose because a helical twisted direction or a helical pitch P derived from the compound varies.

The chiral agent is not particularly limited, and a well-known compound (for example, Liquid Crystal Device Handbook (No. 142 Committee of Japan Society for the Promotion of Science, 1989), Chapter 3, Article 4-3, chiral agent for twisted nematic (TN) or super twisted nematic (STN), p. 199), isosorbide, or an isomannide derivative can be used.

In general, the chiral agent includes a chiral carbon atom. However, an axially chiral compound or a planar chiral compound not having a chiral carbon atom can also be used as the chiral agent. Examples of the axially chiral compound or the planar chiral compound include binaphthyl, helicene, paracyclophane, and derivatives thereof. The chiral agent may include a polymerizable group. In a case where both the chiral agent and the liquid crystal compound have a polymerizable group, a polymer which includes a repeating unit derived from the polymerizable liquid crystal compound and a repeating unit derived from the chiral agent can be formed due to a polymerization reaction of a polymerizable chiral agent and the polymerizable liquid crystal compound. In this aspect, it is preferable that the polymerizable group in the polymerizable chiral agent is the same as the polymerizable group in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

In a case where the chiral agent includes a photoisomerization group, a pattern having a desired reflection wavelength corresponding to a luminescence wavelength can be formed by irradiation of an actinic ray or the like through a photo mask after coating and alignment, which is preferable. As the photoisomerization group, an isomerization portion of a photochromic compound, an azo group, an azoxy group, or a cinnamoyl group is preferable. Specific examples of the compound include compounds described in JP2002-80478A, JP2002-80851A, JP2002-179668A, JP2002-179669A, JP2002-179670A, JP2002-179681A, JP2002-179682A, JP2002-338575A, JP2002-338668A, JP2003-313189A, and JP2003-313292A.

The content of the chiral agent in the liquid crystal composition is preferably 0.01 to 200 mol % and more preferably 1 to 30 mol % with respect to the content molar amount of the liquid crystal compound.

In a case where the liquid crystal layer 34 is formed, it is preferable that the liquid crystal layer 34 is formed by applying the liquid crystal composition to a surface where the liquid crystal layer 34 is to be formed, aligning the liquid crystal compound 30 to a state of a desired liquid crystal phase, and curing the liquid crystal compound 30.

That is, in a case where the cholesteric liquid crystal layer is formed on the alignment film 24, it is preferable that the liquid crystal layer 34 obtained by immobilizing a cholesteric liquid crystal phase is formed by applying the liquid crystal composition to the alignment film 24, aligning the liquid crystal compound 30 to a state of a cholesteric liquid crystal phase, and curing the liquid crystal compound 30.

The applied liquid crystal composition is optionally dried and/or heated and then is cured to form the liquid crystal layer. In the drying and/or heating step, the liquid crystal compound 30 in the liquid crystal composition only has to be aligned to a cholesteric liquid crystal phase. In the case of heating, the heating temperature is preferably 200° C. or lower and more preferably 130° C. or lower.

The aligned liquid crystal compound 30 is optionally further polymerized. Regarding the polymerization, thermal polymerization or photopolymerization using light irradiation may be performed, and photopolymerization is preferable. Regarding this point, the same can also be applied to the above-described optically-anisotropic layer 26.

Regarding the light irradiation, ultraviolet light is preferably used. The irradiation energy is preferably 20 mJ/cm² to 50 J/cm² and more preferably 50 to 1500 mJ/cm². In order to promote a photopolymerization reaction, light irradiation may be performed under heating conditions or in a nitrogen atmosphere. The wavelength of irradiated ultraviolet light is preferably 250 to 430 nm.

The thickness of the liquid crystal layer 34 is not particularly limited, and the thickness with which a required light reflectivity can be obtained may be appropriately set depending on the use of the diffraction element, the light reflectivity required for the liquid crystal layer, the material for forming the liquid crystal layer 34, and the like.

As described above, the optical element according to the embodiment of the present invention can be used as, for example, a liquid crystal lens. That is, an optical element manufactured using the method of manufacturing an optical element according to the embodiment of the present invention can be used as an optical film that focuses or diffuses light.

In addition, the optical element manufactured using the method of manufacturing an optical element according to the embodiment of the present invention can be used as a sheet-like liquid crystal lens or the like and is much thinner than an optical lens such as a convex lens in the related art. Accordingly, by using the optical element manufactured using the method of manufacturing an optical element according to the embodiment of the present invention, a reduction in size and thickness of an optical device can be realized.

The optical element can be suitably used for various optical devices, for example, a head-mounted display (HMD) such as Augmented Reality (AR) glasses that display a virtual image, various information, or the like to be superimposed on a scene that is actually being seen or Virtual Reality (VR) goggles that display an artificially-created virtual space as real, or a projector.

Hereinabove, the beam combiner, the method of forming an alignment film, and the method of manufacturing an optical element according to the embodiment of the present invention have been described in detail. However, the present invention is not limited to the above-described examples, and various improvements and modifications can be made within a range not departing from the scope of the present invention.

### EXAMPLES

Hereinafter, the characteristics of the present invention will be described in detail using examples. Materials, chemicals, used amounts, material amounts, ratios, treatment details, treatment procedures, and the like shown in the following examples can be appropriately changed within a range not departing from the scope of the present invention. Accordingly, the scope of the present invention is not limited to the following specific examples.

### Example 1

A beam combiner having the same configuration as that of FIG. 1 except that the polarization compensating element was not provided was manufactured.

As the light source, a solid-state laser of a wavelength of 355 nm was used.

As the beam splitter element, a commercially available polarization beam splitter (PBSW-20-350, manufactured by Sigmakoki Co., Ltd.) was used. As the polarization conversion element, a commercially available ¼ wave plate (WPQ-3550-4M, manufactured by Sigmakoki Co., Ltd.) was used. The ¼ wave plate was a zero-order wave plate where two quartz plates were bonded. The beam splitter element and the polarization conversion element were provided such that, as in FIG. 1, the optical path side (first optical path side) where the light control element was provided immediately below the polarization conversion element was a left circularly polarized light side and the optical path side (second optical path side) where the light control element was not provided was a right circularly polarized light side.

As the light control element, a convex lens having a focal length of 90 mm was used.

As the beam combiner element, a cube type beam splitter was used. This beam splitter is a non-polarization beam splitter.

### Example 2

A beam combiner was manufactured using the same method as that of Example 1, except that a cholesteric liquid crystal layer having a selective reflection center wavelength of 355 nm and selectively reflecting right circularly polarized light was used instead of the polarization beam splitter element and one ½ wave plate was used instead of the ¼ wave plate as the polarization conversion element. As the ½ wave plate, a commercially available product (WPQ-3550-2M, manufactured by Sigmakoki Co., Ltd.) was used.

An optical path transmitting through the cholesteric liquid crystal layer was the optical path (first optical path) where the light control element was provided, and the ½ wave plate was inserted into the optical path (second optical path) of right circularly polarized light reflected from the cholesteric liquid crystal layer.

The cholesteric liquid crystal layer was manufactured as follows.

A glass substrate was used as the support.

The following coating liquid for forming an alignment film was applied to the support by spin coating. The support on which the coating film of the coating liquid for forming an alignment film was formed was dried using a hot plate at 60° C. for 60 seconds. As a result, an alignment film was formed.

### Coating Liquid for Forming Alignment Film

| | | |
|---|---|---|
| Material A for photo-alignment | . . . | 1.00 part by mass |
| Water | . . . | 16.00 parts by mass |
| Butoxyethanol | . . . | 42.00 parts by mass |
| Propylene glycol monomethyl ether | . . . | 42.00 parts by mass |

-Material A for Photo-Alignment-

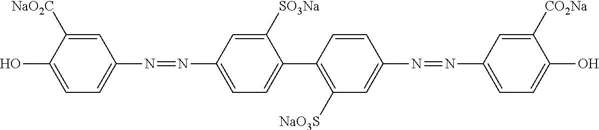

This alignment film was irradiated with light emitted from a high-pressure mercury lamp at 200 mJ/cm² through a wire grid polarizer. The following liquid crystal composition was applied to the irradiated alignment film to form a coating film, and the coating film was heated using a hot plate at 80° C.

Next, the coating film was irradiated with ultraviolet light having a wavelength of 365 nm at an irradiation dose of 300 mJ/cm² using a high-pressure mercury lamp in a nitrogen atmosphere. As a result, the alignment of the liquid crystal compound was immobilized.

### Liquid Crystal Composition

| | | |
|---|---|---|
| Liquid crystal compound L-1 | . . . | 100.00 parts by mass |
| Polymerization initiator (IRGACURE-OXE01, manufactured by BASF SE) | . . . | 1.00 part by mass |
| Chiral agent Ch-1 | . . . | 4.58 parts by mass |
| Leveling agent T-1 | . . . | 0.10 parts by mass |
| Methyl ethyl ketone | . . . | 317.04 parts by mass |

Chiral Agent Ch-1

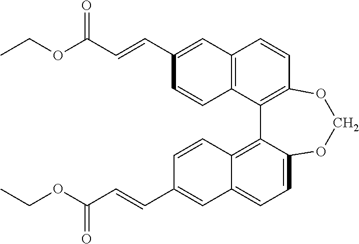

Leveling Agent T-1

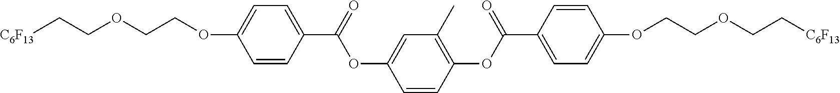

By providing the cholesteric liquid crystal layer such that the main surface was tilted by 45° with respect to the optical axis of light emitted from the light source, right circularly polarized light was reflected, and left circularly polarized light transmitted through the cholesteric liquid crystal layer.

### Example 3

A beam combiner was manufactured using the same method as that of Example 1, except that a positive C-plate was disposed as the polarization compensating element between the light control element and the beam combiner element on the optical path (first optical path) where the light control element was provided.

The positive C-plate was disposed such that the main surface was tilted by −45° with respect to the optical axis of right circularly polarized light as shown in FIG. 3. In addition, a retardation during incidence of light having a wavelength λ into the positive C-plate from a direction of −45° with respect to the main surface was 0.125λ.

The retardation was measured using a spectroscopic ellipsometer (M-2000, manufactured by J. A. Woollam Co., Inc.) in a case where light having the wavelength λ (λ=355 nm) was incident from the direction of 45° with respect to the main surface. Regarding this point, the same can also be applied to Examples 4 and 5.

### Example 4

A beam combiner was manufactured using the same method as that of Example 1, except that an O-plate was disposed as the polarization compensating element between the light control element and the beam combiner element on the optical path (first optical path) where the light control element was provided.

In the O-plate, the liquid crystal compound was tilted and aligned by −45° with respect to the main surface, and the O-plate was disposed such that the normal line and the optical axis of right circularly polarized light matched with each other as shown in FIG. 4. In addition, in the O-plate, a retardation during incidence of light having the wavelength λ from a direction orthogonal to the tilt alignment direction of the liquid crystal compound was 0.25λ.

### Example 5

A beam combiner was manufactured using the same method as that of Example 1, except that a positive C-plate was disposed as the polarization compensating element between the light control element and the beam combiner element on the optical path (first optical path) where the light control element was provided and a positive C-plate was disposed as the polarization compensating element between the polarization conversion element (¼ wave plate) and the beam combiner element on the optical path (second optical path) where the light control element was not provided.

That is, this beam combiner has the same configuration as that of FIG. 1.

The positive C-plate was disposed such that the first optical path side where the light control element was provided was tilted by −45° with respect to the optical axis of circularly polarized light corresponding to the main surface as shown in FIG. 3. In addition, a retardation during incidence of light having a wavelength λ into the positive C-plate from a direction of −45° with respect to the main surface was 0.125λ.

In addition, the positive C-plate was disposed such that the second optical path side where the light control element was not provided was tilted by +45° with respect to the optical axis of circularly polarized light corresponding to the main surface as shown in FIG. 3. In addition, a retardation during incidence of light having a wavelength λ into the positive C-plate from a direction of +45° with respect to the main surface was 0.125λ.

### Comparative Example 1

A beam combiner was manufactured using the same method as that of Example 1, except that the same polarization beam splitter as the beam splitter element was used as the beam combiner element.

### [Measurement of Ellipticity]

Regarding each of the manufactured beam combiners, an ellipticity of right circularly polarized light and left circularly polarized light emitted from the beam combiner element was measured as follows.

A λ/4 plate and a polarizer were disposed on the emission side of the beam combiner element. In this state, an optical system was prepared to measure a light intensity using a power meter in a case where the light transmitted through the beam combiner element transmitted through the λ/4 plate and the polarizer in this order.

In order to measure the measurement region, a light screen having an opening of 1 mmp was provided before the power meter. The polarizer and the power meter were disposed parallel to an angle at which a photosensitive material was provided, and the λ/4 plate was disposed perpendicular to the optical axis of the light transmitted through the beam combiner element.

Using this optical system, the ellipticity was calculated from a change in intensity of the transmitted light obtained by rotating the λ/4 plate and the polarizer. The evaluation is as follows.
A: the absolute value of the ellipticity was 0.9 or more
B: the absolute value of the ellipticity was 0.8 or more and less than 0.9
C: the absolute value of the ellipticity was less than 0.8

### [Evaluation of Alignment Pattern]

### (Support)

A glass substrate was used as the support.

### (Formation of Alignment Film)

An alignment film was formed on the support with the same method as that of Example 2 using the same coating liquid for forming an alignment film as that of Example 2.

### (Exposure of Alignment Film)

Using each of the beam combiners according to Comparative Example 1 and Examples 1 to 5, the formed alignment film was exposed, and an alignment film P-1 having an alignment pattern including a pattern where a short straight line (short line) changed while continuously rotating in one direction in a radial shape was formed as shown in FIG. 2.

The single period Λ in the alignment pattern of the alignment film changed in a plane, and the minimum value thereof was 1 μm. The single period Λ of the alignment pattern was adjusted based on the focal length of a convex lens used as the optical element.

As the light source, a light source that emitted laser light having a wavelength of 355 nm as described above was used. The exposure amount of the interference light was 1000 mJ/cm².

### (Formation of Optically-Anisotropic Layer for Pattern Observation)

As a liquid crystal composition forming an optically-anisotropic layer A-1, the following liquid crystal composition A-1 was prepared.

### Liquid Crystal Composition A-1

| | | |
|---|---|---|
| Liquid crystal compound L-1 | . . . | 100.00 parts by mass |
| Polymerization initiator (IRGACURE-OXE01, manufactured by BASF SE) | . . . | 1.00 part by mass |
| Leveling agent T-1 | . . . | 0.08 parts by mass |
| Methyl ethyl ketone | . . . | 1050.00 parts by mass |

Liquid Crystal Compound L-1

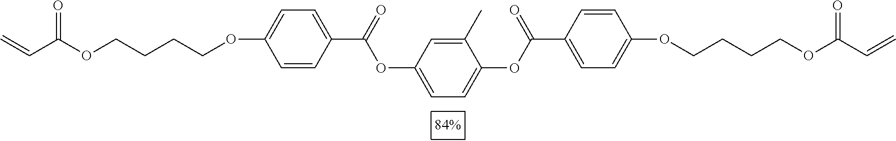 [SMILES: C=CC(=O)OCCCCOc1ccc(C(=O)Oc2ccc(OC(=O)c3ccc(OCCCCOC(=O)C=C)cc3)c(C)c2)cc1]

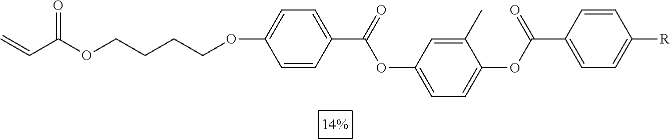

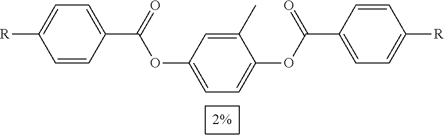

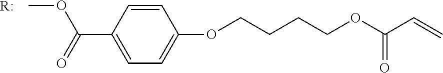

Leveling Agent T-1

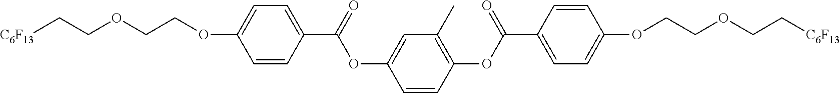

The liquid crystal composition A-1 was applied to the alignment film P-1 to form a coating film, and the coating film was heated using a hot plate at 80° C. Next, the coating film was irradiated with ultraviolet light having a wavelength of 365 nm at an irradiation dose of 300 mJ/cm² using a high-pressure mercury lamp in a nitrogen atmosphere. As a result, the alignment of the liquid crystal compound was immobilized.

This way, an optical element for pattern observation where the alignment film P-1 and the optically-anisotropic layer A-1 were laminated in this order on the glass substrate was obtained.

### (Pattern Observation 1)

The obtained optical element for pattern observation was rotated and observed below the polarizer where an absorption axis was disposed in a crossed nicols arrangement.

As a result, in the exposed portion of the optical element (the portion having the alignment pattern), the brightness was uniform without a change in brightness, and whether or not angle arrangement for light extinction was present was checked.

This implies that, on average in a plane, uniform optical characteristics are exhibited irrespective of the angle relationship with the absorption axis of the polarizing plate in the crossed nicols arrangement, and the alignment pattern where the alignment axis rotates is formed.

### (Pattern Observation 2)

In addition, in a case where the obtained optical element for pattern observation was observed in a crossed nicols arrangement of an optical microscope, a clear alignment pattern where dark portions and bright portions alternately appeared was able to be verified.

Based on the pattern observation 1 and the pattern observation 2, the interference pattern was evaluated.

The evaluation is as follows.
A: a clear alignment pattern where bright portions and dark portions alternately appeared was able to be verified irrespective of the installation orientation of the sample, and the line width between a bright portion and a dark portion adjacent to each other was substantially regular
B: a clear alignment pattern where dark portions and bright portions alternately appeared was able to be verified, but the line width between a bright portion and a dark portion adjacent to each other varied depending on the installation orientation of the sample
C: the alignment pattern was unclear depending on the installation orientation of the sample

The results are shown in the following table. In the following table, for convenience of description, it is assumed that the optical path where the light control element was provided was the first optical path, and the optical path where the light control element was not provided was the second optical path.

TABLE 1

| | | | | | | | | Ellipticity of Circularly | | |
|---|---|---|---|---|---|---|---|---|---|---|
| | | | | | | | | Polarized Light | | |
| | | | | | | | | First | Second | |
| | Polarization Separating | | | | | | | Optical | Optical | |
| | Element | | | | | | | Path (Right | Path (Left | |
| | | Polarization | Polarization Compensating Element | | | | Beam | Circularly | Circularly | |
| | Separating | Conversion | First Optical Path | | Second Optical Path | | Combiner | Polarized | Polarized | Alignment |
| | Element | Element | Kind | Retardation | Kind | Retardation | Element | Light) | Light) | Pattern |
| Comparative | Polarization | λ/4 Wave | — | — | — | — | Polarized | C | C | C |
| Example 1 | Beam | Plate | | | | | Light | | | |
| | Splitter | | | | | | | | | |
| Example 1 | Polarization | λ/4 Wave | — | — | — | — | Unpolarized | B | B | A |
| | Beam | Plate | | | | | Light | | | |
| | Splitter | | | | | | | | | |
| Example 2 | Cholesteric | λ/2 Wave | — | — | — | — | Unpolarized | B | B | A |
| | Liquid | Plate | | | | | Light | | | |
| | Crystal | | | | | | | | | |
| | Layer | | | | | | | | | |
| Example 3 | Polarization | λ/4 Wave | C-Plate | 0.125λ | — | — | Unpolarized | A | B | A |
| | Beam | Plate | | | | | Light | | | |
| | Splitter | | | | | | | | | |
| Example 4 | Polarization | λ/4 Wave | O-Plate | 0.25λ | — | — | Unpolarized | A | B | A |
| | Beam | Plate | | | | | Light | | | |
| | Splitter | | | | | | | | | |
| Example 5 | Polarization | λ/4 Wave | C-Plate | 0.125λ | C-Plate | 0.125λ | Unpolarized | A | A | A |
| | Beam | Plate | | | | | Light | | | |
| | Splitter | | | | | | | | | |

As shown in the above-described table, in the beam combiner according to the embodiment of the present invention where the absolute value of the ellipticity of both right circularly polarized light and left circularly polarized light emitted from the beam combiner element is 0.8 or more, a clearer alignment pattern (interference pattern) can be formed as compared to the beam combiner according to Comparative Examples where the absolute value of the ellipticity of both right circularly polarized light and left circularly polarized light emitted from the beam combiner element is less than 0.8.

In addition, as shown in Examples 3 to 5, by providing the polarization compensating element on the optical path of circularly polarized light, the absolute value of the ellipticity of circularly polarized light emitted from the beam combiner element can be adjusted to be 0.9 or more.

Further, in the pattern observation 2, in Examples 3 and 4 where the polarization compensating element was provided on the first optical path, a clearer alignment pattern was observed as compared to Examples 1 and 2 where the polarization compensating element was not used. In Example 5 where the polarization compensating element was provided on both of the first optical path and the second optical path, a much clearer alignment pattern was observed.

As can be seen from the above results, the effects of the present invention are obvious.

The present invention can be suitably used for manufacturing optical elements forming various optical devices.

### EXPLANATION OF REFERENCES

10, 36: optical element
20: support
24: alignment film
26, 26A: optically-anisotropic layer
30: liquid crystal compound
30A: optical axis
34, 34A: (cholesteric) liquid crystal layer
50: beam combiner
52: light source
54: polarization separating element
56a, 56b, 76: mirror
58: light control element
60: beam combiner element
60a: first surface
60b: second surface
62a, 62b: polarization compensating element
62ac, 62bc: positive C-plate
62aO, 62bO: O-plate
64: beam splitter element
68a, 68b: polarization conversion element
70: beam expander element
72: optical path adjustment optical system
74a, 74b: actuated mirror
78a, 78b: detector
100: beam combiner
102: light source
104: polarization beam splitter
106a, 106b: mirror
108: light control element
110: half mirror
112: λ/4 plate
M: light
MR: right circularly polarized light
ML: left circularly polarized light
Z: photosensitive material

What is claimed is:

1. A beam combiner comprising:
a beam combiner element that includes a first surface through which at least a part of right circularly polarized light and left circularly polarized light transmits and a second surface from which at least a part of right circularly polarized light and left circularly polarized light is reflected and emits light where the light transmitted through the first surface and the light reflected from the second surface are combined;
a polarization separating element that separates light incident into the beam combiner element into two right circularly polarized light components or two left circularly polarized light components to convert the incidence light into right circularly polarized light or left circularly polarized light; and
at least one light control element that focuses or diffuses light and is provided on at least one of an optical path of the right circularly polarized light or the left circularly polarized light incident into the first surface of the beam combiner element or an optical path of circularly polarized light incident into the second surface of the beam combiner element and having the same turning direction as the circularly polarized light incident into the first surface,
wherein an absolute value of an ellipticity of the right circularly polarized light or the left circularly polarized light incident into, transmitted through, and emitted from the first surface of the beam combiner element is 0.8 or more, and
an absolute value of an ellipticity of circularly polarized light incident into, reflected from, and emitted from the second surface of the beam combiner element and having a turning direction opposite to that of the circularly polarized light incident into, transmitted through, and emitted from the first surface of the beam combiner element is 0.8 or more.

2. The beam combiner according to claim 1,
wherein the polarization separating element includes a beam splitter that separates incidence light into two linearly polarized light components orthogonal to each other, a first polarization conversion element that converts one linearly polarized light separated by the beam splitter into the right circularly polarized light or the left circularly polarized light, and a second polarization conversion element that converts the other linearly polarized light separated by the beam splitter into circularly polarized light having the same turning direction as the circularly polarized light converted by the first polarization conversion element.

3. The beam combiner according to claim 1,
wherein the polarization separating element includes a layer that separates incident light into circularly polarized light components having opposite turning directions and is formed by immobilizing a cholesteric liquid crystal phase, and a polarization conversion element that converts one circularly polarized light separated by the layer formed by immobilizing the cholesteric liquid crystal phase into circularly polarized light having the same turning direction as the other circularly polarized light.

4. The beam combiner according to claim 2, further comprising:
a polarization compensating element that is provided between the light control element and the beam combiner element.

5. The beam combiner according to claim 4, further comprising:
a polarization compensating element that is provided between the polarization separating element and the beam combiner element on an optical path where the light control element is not disposed.

6. The beam combiner according to claim 4,
wherein the polarization compensating element is a positive C-plate.

7. The beam combiner according to claim 6,
wherein a retardation during incidence of light having a wavelength λ into the positive C-plate from a direction of 45° with respect to a main surface is 0.12λ to 0.13λ, and
the positive C-plate is at least one of a first positive C-plate that is provided on an optical path of light incident into the first surface of the beam combiner element such that a main surface is disposed to form −45° with respect to an optical axis of the incidence light or a second positive C-plate that is provided on an optical path of light incident into the second surface of the beam combiner element such that a main surface is disposed to form +45° with respect to an optical axis of the incidence light.

8. The beam combiner according to claim 5,
wherein the polarization compensating element is a positive C-plate.

9. The beam combiner according to claim 8,
wherein a retardation during incidence of light having a wavelength λ into the positive C-plate from a direction of 45° with respect to a main surface is 0.12λ to 0.13λ, and
the positive C-plate is at least one of a first positive C-plate that is provided on an optical path of light incident into the first surface of the beam combiner element such that a main surface is disposed to form −45° with respect to an optical axis of the incidence light or a second positive C-plate that is provided on an optical path of light incident into the second surface of the beam combiner element such that a main surface is disposed to form +45° with respect to an optical axis of the incidence light.

10. The beam combiner according to claim 4,
wherein the polarization compensating element is an O-plate.

11. The beam combiner according to claim 10,
wherein the O-plate is at least one of
a first O-plate that is provided on an optical path of light incident into the first surface of the beam combiner element and where a direction having a highest refractive index is tilted by −45° with respect to a main surface and a retardation during vertical incidence of light having a wavelength λ with respect to the direction having the highest refractive index is 0.24 to 0.26λ or
a second O-plate that is provided on an optical path of light incident into the second surface of the beam combiner element and where a direction having a highest refractive index is tilted by 45° with respect to a main surface and a retardation during vertical incidence of light having a wavelength λ with respect to the direction having the highest refractive index is 0.24 to 0.26K.

12. The beam combiner according to claim 5,
wherein the polarization compensating element is an O-plate.

13. The beam combiner according to claim 12,
wherein the O-plate is at least one of
a first O-plate that is provided on an optical path of light incident into the first surface of the beam combiner element and where a direction having a highest refractive index is tilted by −45° with respect to a main surface and a retardation during vertical incidence of light having a wavelength λ with respect to the direction having the highest refractive index is 0.24 to 0.26λ or
a second O-plate that is provided on an optical path of light incident into the second surface of the beam combiner element and where a direction having a highest refractive index is tilted by 450 with respect to a main surface and a retardation during vertical incidence of light having a wavelength λ with respect to the direction having the highest refractive index is 0.24 to 0.26λ.

14. The beam combiner according to claim 2,
wherein in a case where parallel light is incident into the light control element, at least a part of the light emitted from the beam combiner element has an angle of 15° or more with respect to an optical axis of the light control element.

15. A method of forming an alignment film, the method comprising:
irradiating a coating film including a compound having a photo-aligned group with light emitted from the beam combiner according to claim 2.

16. A method of manufacturing an optical element, the method comprising:
a step of applying a composition including a liquid crystal compound to an alignment film formed using the method of forming an alignment film according to claim 15, and drying the applied composition.

17. The beam combiner according to claim 3, further comprising:
a polarization compensating element that is provided between the light control element and the beam combiner element.

18. The beam combiner according to claim 17, further comprising:
a polarization compensating element that is provided between the polarization separating element and the beam combiner element on an optical path where the light control element is not disposed.

19. The beam combiner according to claim 17,
wherein the polarization compensating element is a positive C-plate.

20. The beam combiner according to claim 19,
wherein a retardation during incidence of light having a wavelength λ into the positive C-plate from a direction of 45° with respect to a main surface is 0.12λ to 0.13λ, and
the positive C-plate is at least one of a first positive C-plate that is provided on an optical path of light incident into the first surface of the beam combiner element such that a main surface is disposed to form −45° with respect to an optical axis of the incidence light or a second positive C-plate that is provided on an optical path of light incident into the second surface of the beam combiner element such that a main surface is disposed to form +45° with respect to an optical axis of the incidence light.
